(19) United States
(12) Patent Application Publication
(10) Pub. No.: US 2021/0254850 A1
(43) Pub. Date: Aug. 19, 2021

(54) USER CONTROL DEVICE WITH IN-HOME MONITORING

(71) Applicant: Johnson Controls Technology Company, Auburn Hills, MI (US)

(72) Inventor: Timothy E. Field, West Bend, WI (US)

(73) Assignee: Johnson Controls Technology Company, Auburn Hills, MI (US)

(21) Appl. No.: 17/175,562

(22) Filed: Feb. 12, 2021

Related U.S. Application Data
(60) Provisional application No. 62/976,045, filed on Feb. 13, 2020.

(51) Int. Cl. F24F 11/56; F24F 11/30; F24F 11/63; H04N 5/33

(52) U.S. Cl. CPC F24F 11/56; F24F 11/30; F24F 2120/14; H04N 5/33; F24F 11/63

(57) ABSTRACT

A space controller includes a housing, a sensor, a communications interface, a camera lens, a camera, a display, and a processing circuit. The sensor and the communications interface are coupled to the housing. The sensor is configured to generate sensor data that is indicative of a condition of an environment surrounding the housing. The communications interface is configured to communicate with a controlled device. The camera and the processing circuit are positioned within the housing. In particular, the camera is aligned with the camera lens. The display is configured to display images received from the camera and to receive user input. The processing circuit is configured to identify the environmental condition based on the sensor data and to operate the controlled device based on the environmental condition and the user input.

### CROSS-REFERENCE TO RELATED PATENT APPLICATIONS

This application claims the benefit of and priority to U.S. Provisional Application No. 62/976,045, filed Feb. 13, 2020, incorporated herein by reference in its entirety.

### BACKGROUND

The present disclosure relates generally to user control devices and more particularly to thermostats for controlling a building or space's heating, ventilating, and air conditioning (HVAC) system.

A thermostat is, in general, a component of an HVAC control system. Traditional thermostats sense the temperature or other parameters (e.g., humidity) of a system and control components of the HVAC system in order to maintain a set point for the temperature or other parameter. A thermostat may be designed to control a heating or cooling system or an air conditioner. Thermostats are manufactured in many ways, and use a variety of sensors to measure temperature and other desired parameters of a system.

Conventional thermostats are configured for one-way communication to connected components, and to control HVAC systems by turning on or off certain components or by regulating flow. Each thermostat may include a temperature sensor and a user interface. The user interface typically includes display for presenting information to a user and one or more user interface elements for receiving input from a user. To control the temperature of a building or space, a user adjusts the set point via the thermostat's user interface.

### SUMMARY

One embodiment of the present disclosure relates to a space controller. The space controller includes a housing, a sensor, a communications interface, a camera lens, a camera, a display, and a processing circuit. The sensor and the communications interface are coupled to the housing. The sensor is configured to generate sensor data that is indicative of a condition of an environment surrounding the housing. The communications interface is configured to communicate with a controlled device. The camera and the processing circuit are positioned within the housing. In particular, the camera is aligned with the camera lens. The display is configured to display images received from the camera and to receive user input. The processing circuit is configured to identify the environmental condition based on the sensor data and to operate the controlled device based on the environmental condition and the user input.

In some embodiments, the display is a touch sensitive display and the display is configured to display the images from the camera in real-time.

In some embodiments, the processing circuit is configured to determine an event based on the images received from the camera. The processing circuit may be configured to operate the controlled device based on the event. In some implementations, the event may be one of a movement, a face recognition, and a person's skin temperature.

In some embodiments, the environmental condition is one of a temperature of the environment surrounding the housing, a humidity of the environment surrounding the housing, an air quality of the environment surrounding the housing, or an amount of lighting in an environment surrounding the housing. For example, the sensor may include a temperature sensor configured to measure a temperature. In this scenario, the user input may include a temperature preference and the processing circuit may be configured to operate the controlled device based on the temperature preference.

In some embodiments, the communications interface is configured to transmit images received from the camera to a remote device and to receive commands from the remote device. The processing circuit may be configured to control the camera based on the commands.

In some embodiments, the camera includes a complementary metal oxide semiconductor (CMOS) sensor. In some embodiments, the camera includes an infrared sensor.

Another embodiment of the present disclosure relates to a building control system. The building control system includes a space controller, a sensor, a camera, and a controlled device. The space controller is configured to operate the controlled device to affect an environmental condition of a space within a building. The space controller includes a display configured to receive user input. The sensor is communicably coupled to the space controller and is configured to generate sensor data that is indicative of the environmental condition of the space. The camera is communicably coupled to the space controller and is configured to generate images. The display is configured to display images received from the camera. The controlled device is communicably coupled to the space controller and is operable to affect the environmental condition of the space based on the sensor data and the user input.

In some embodiments, the space controller is configured to determine an event based on the images received from the camera. The space controller is configured to operate the controlled device based on the event.

Another embodiment of the present disclosure relates to a building control system. The building control system includes a space controller, a sensor, and a monitoring device. The space controller is configured to operate a controlled device to affect an environmental condition of a space within a building. The space controller includes a user interface configured to receive user input. The sensor is communicably coupled to the space controller and is configured to generate sensor data that is indicative of the environmental condition of the space. The monitoring device is communicably coupled to the space controller and is configured to generate data including one of sound and images. The user interface is operable to provide an indication of the data received from the monitoring device.

In some embodiments, the user interface is configured to activate in response to data indicating one of a sound level that is above a predefined threshold and images corresponding to movement within the space.

In some embodiments, the building control system further comprises a communications interface configured to transmit images received from the recording device to a remote device and to receive commands from the remote device. The space controller may be configured to operate based on the commands.

Another embodiment of the present disclosure is a method. The method includes receiving, by a processing circuit onboard a space controller, sensor data from a sensor. The sensor data is indicative of an environmental condition of a space within the building. The method also includes receiving, by the processing circuit, images from a camera within the space and receiving, by the processing circuit, user input including an environmental condition preference. The method additionally includes displaying, on a display of the space controller, the images from the camera. The method further includes operating, by the processing circuit, a controlled device to change the environmental condition of the space based on the sensor data and the user input.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a drawing of a building equipped with a HVAC system, according to an illustrative embodiment.

FIG. 2 is a block diagram of a waterside system that may be used in conjunction with the building of FIG. 1, according to an illustrative embodiment.

FIG. 3 is a block diagram of an airside system that may be used in conjunction with the building of FIG. 1, according to an illustrative embodiment.

FIG. 4 is a drawing of a space controller with a transparent display, according to an illustrative embodiment.

FIG. 5 is a schematic drawing of a building equipped with a residential heating and cooling system and the space controller of FIG. 4, according to an illustrative embodiment.

FIG. 6 is a schematic drawing of the space controller of FIG. 4 and the residential heating and cooling system of FIG. 5, according to an illustrative embodiment.

FIG. 7 is a front view of the space controller of FIG. 4.

FIG. 8 is a front view of the space controller of FIG. 4 with a camera lens removed.

FIG. 9 is a side view of the space controller of FIG. 4.

FIG. 10 is an exploded view of the space controller of FIG. 4.

FIG. 11 is a floorplan of a building with space controllers/sensor units in multiple rooms, according to an illustrative embodiment.

FIG. 12 is a view of the space controller of FIG. 4 attached to a wall and displaying an image from the camera, according to an illustrative embodiment.

FIG. 13 is a diagram illustrating a space controller functioning as video teleconference device, according to an illustrative embodiment.

FIG. 14 is a diagram illustrating a space controller functioning as an in-home monitor, according to an illustrative embodiment.

FIG. 15 is a block diagram of a space controller, according to an illustrative embodiment.

FIG. 16 is a flow diagram of a method of operating a space controller, according to an illustrative embodiment.

FIG. 17 is a flow diagram of a method of transmitting data between a space controller and a remote device, according to an illustrative embodiment.

### DETAILED DESCRIPTION

Referring generally to the Figures, a space controller is shown, according to various exemplary embodiments. The space controller may be implemented as a thermostat to control a HVAC system in any of a variety of environments (e.g., a home, a building, a classroom, a hotel, a healthcare facility, a vehicle, etc.) and used to monitor, control, and/or facilitate user interaction with controllable systems or devices in such environments. For example, the space controller may be a thermostat installed in a home or building (e.g., mounted on a wall) that is configured to control HVAC equipment.

According to an exemplary embodiment, the space controller includes a housing that contains electronic components and a touch-sensitive display for displaying visual media (e.g., information, text, graphics, videos, etc.) to a user and receiving user inputs. The housing is selectively attached to a mounting plate to mount the space controller to a mounting surface such as a wall.

The space controller can be equipped with one or more of a variety of sensors (e.g., temperature, humidity, air quality, proximity, light, vibration, motion, optical, audio, occupancy, power, security, etc.) configured to sense a variable state or condition of the environment in which the space controller is installed. In an exemplary embodiment, the space controller is equipped with a monitoring device (e.g., a camera, a microphone, etc.) for monitoring physical disturbances in the environment where the space controller is installed. The camera may be a CMOS sensor, charge coupled device (CCD) sensor, or any other type of image sensor configured to monitor the environment. In some embodiments, the camera may be an infrared camera configured to detect infrared energy and convert it into a thermal image.

According to an exemplary embodiment, the space controller is configured to function as in in-home monitor. For example, the space controller may be configured to display the image captured by the camera of the space controller on the user interface of the space controller, such as a touch-sensitive panel or electronic display. Additionally, the space controller may be configured to display the image captured by the camera of a separate, network connected space controller. For example, the space controller may display the image from a mobile device on the user interface. In some embodiments, the space controller includes an infrared camera and/or infrared sensors configured to capture thermal data from areas within a room (e.g., in low-light conditions). The space controller may also have motion sensors configured to activate the camera or a variety of other sensors. The space controller may further include a microphone configured to allow for audio and video communication between separate space controllers and/or mobile devices.

The space controller is configured to function as thermostat and to control HVAC equipment based on images captured by the camera. For example, the space controller may be configured to recognize faces and adjust the temperature according to presets assigned to each face. The space controller may be configured with further image processing capability. For example, the space controller may be able to recognize events based on images captured by the camera and/or infrared sensor and alter the temperature according to the events. For example, the space controller may be configured to recognize hand gestures by comparing several images taken by the camera over a predefined period of time, and to generate control commands for various climate control settings based on the hand gestures. According to an exemplary embodiment, the space controller may be configured as an in-home monitor (e.g., baby monitor, room monitor for a patient in a healthcare facility, etc.). For example, the space controller may be configured to control HVAC equipment to control a condition (e.g., temperature, humidity, ventilation, etc.) of a room in response to monitoring a child with the camera and/or infrared sensor. For example, the space controller may be configured to use the camera (e.g., the infrared camera) or infrared sensor to determine a child's skin temperature (e.g., whether a blanket has been removed from the child, etc.) and to control HVAC equipment to increase the temperature in the room if the child becomes cold.

According to an exemplary embodiment, the space controller is configured to provide a caregiver with remote access to images and/or video captured by the camera. The caregiver may access the space controller (e.g., thermostat) using a password through a mobile device (e.g., a mobile phone, a laptop computer, a tablet, or another wirelessly connected device). Additionally, the space controller may be configured to transmit the images and/or video to other user control devices within a building, in separate rooms or areas of the building, so that the images/video can be viewed by caregivers from different locations. The space controller may be configured to receive commands from the mobile device or another space controller within the building to activate various control functions. For example, in an embodiment where the space controller is implemented as a baby monitor, the caregiver may be able to issue control commands to the space controller to activate a nightlight, a light show via the user interface (e.g., display), to play comforting music (e.g. lullabies, bedtime stories, etc.) through a speaker of the user interface, or other control functions.

In some embodiments, the space controller may incorporate other functionality that is useful for a caregiver. For example, the space controller may be programmable and may be configured to perform different routines based on programmable schedules that are saved into onboard memory. For example, the space controller may be configured as a sleep/wake training system for a child or an alarm clock. The space controller may be programmed to activate different colored lights on the user interface depending on the time of day (e.g., a green light at 7:30 AM means it is ok to get out of bed in the morning, etc.) and to perform other controlled routines based on user defined schedules in memory. These routines may be setup by a user directly from the user interface, or remotely through an application on a mobile device.

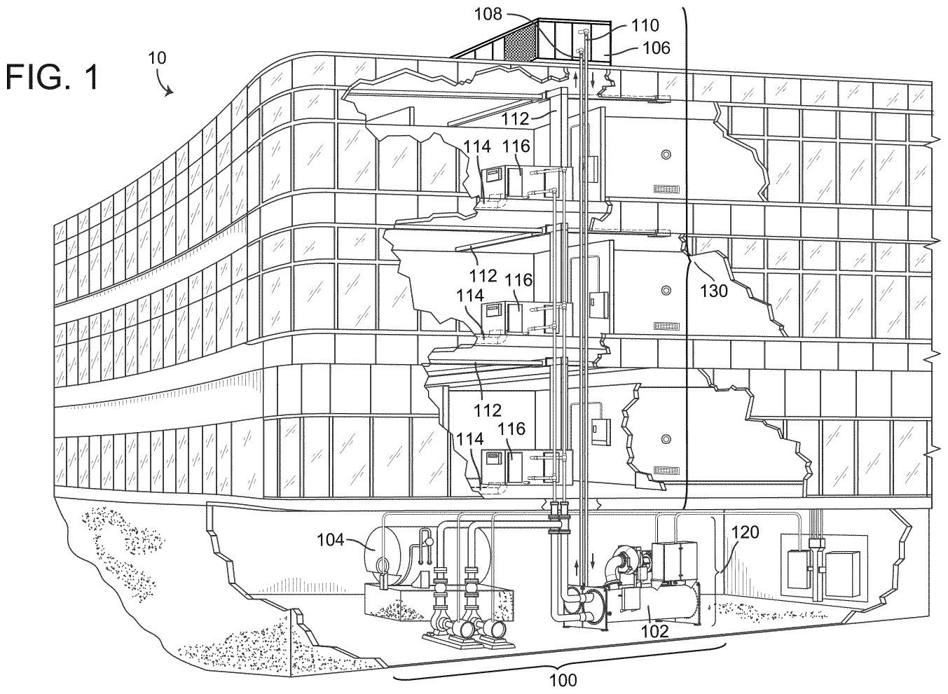

Referring now to FIGS. 1-3, an exemplary building management system (BMS) and HVAC system in which the systems and methods of the present invention can be implemented are shown, according to an exemplary embodiment. Referring particularly to FIG. 1, a perspective view of a building 10 is shown. Building 10 is served by a BMS. A BMS is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof.

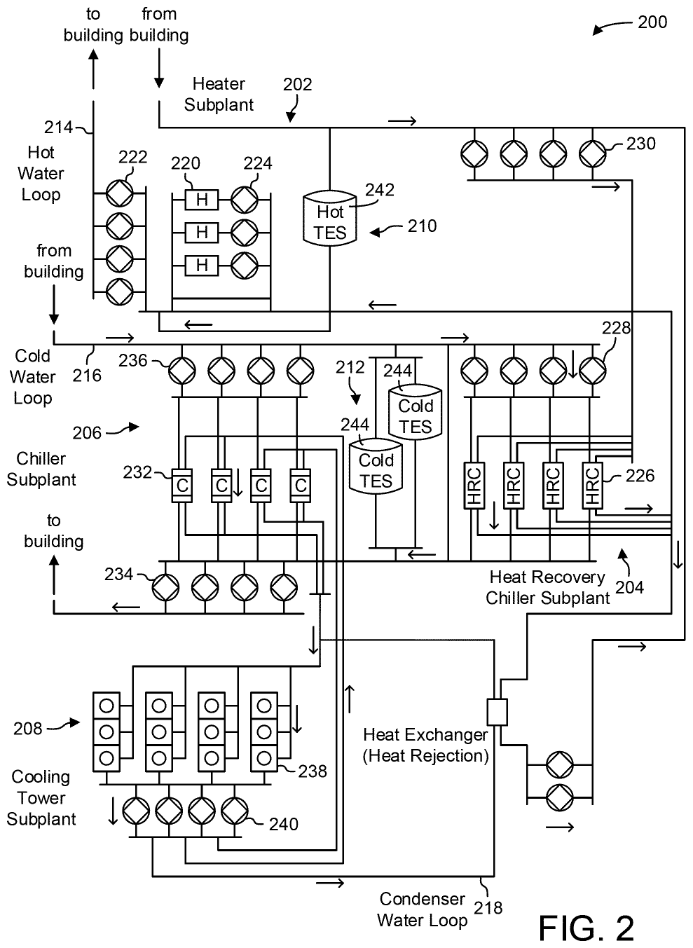

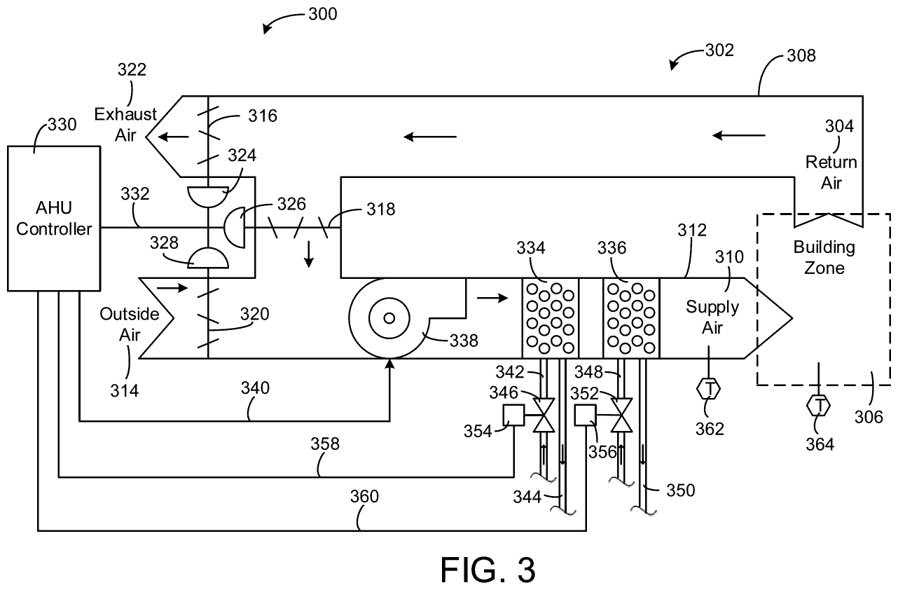

The BMS that serves building 10 includes an HVAC system 100. HVAC system 100 can include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 can provide a heated or chilled fluid to an air handling unit of airside system 130. Airside system 130 can use the heated or chilled fluid to heat or cool an airflow provided to building 10. An exemplary waterside system 120 and airside system 130 which can be used in HVAC system 100 are described in greater detail with reference to FIGS. 2-3.

HVAC system 100 is shown to include a chiller 102, a boiler 104, and a rooftop air handling unit (AHU) 106. Waterside system 120 can use boiler 104 and chiller 102 to heat or cool a working fluid (e.g., water, glycol, etc.) and can circulate the working fluid to AHU 106. In various embodiments, the HVAC devices of waterside system 120 can be located in or around building 10 (as shown in FIG. 1) or at an offsite location such as a central plant (e.g., a chiller plant, a steam plant, a heat plant, etc.). The working fluid can be heated in boiler 104 or cooled in chiller 102, depending on whether heating or cooling is required in building 10. Boiler 104 can add heat to the circulated fluid, for example, by burning a combustible material (e.g., natural gas) or using an electric heating element. Chiller 102 can place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 can be transported to AHU 106 via piping 108.

AHU 106 can place the working fluid in a heat exchange relationship with an airflow passing through AHU 106 (e.g., via one or more stages of cooling coils and/or heating coils). The airflow can be, for example, outside air, return air from within building 10, or a combination of both. AHU 106 can transfer heat between the airflow and the working fluid to provide heating or cooling for the airflow. For example, AHU 106 can include one or more fans or blowers configured to pass the airflow over or through a heat exchanger containing the working fluid. The working fluid can then return to chiller 102 or boiler 104 via piping 110.

Airside system 130 can deliver the airflow supplied by AHU 106 (i.e., the supply airflow) to building 10 via air supply ducts 112 and can provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 can include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 can include various sensors (e.g., temperature sensors, pressure sensors, etc.) configured to measure attributes of the supply airflow. AHU 106 can receive input from sensors located within AHU 106 and/or within the building zone and can adjust the flow rate, temperature, or other attributes of the supply airflow through AHU 106 to achieve set-point conditions for the building zone.

Referring now to FIG. 2, a block diagram of a waterside system 200 is shown, according to an exemplary embodiment. In various embodiments, waterside system 200 can supplement or replace waterside system 120 in HVAC system 100 or can be implemented separate from HVAC system 100. When implemented in HVAC system 100, waterside system 200 can include a subset of the HVAC devices in HVAC system 100 (e.g., boiler 104, chiller 102, pumps, valves, etc.) and can operate to supply a heated or chilled fluid to AHU 106. The HVAC devices of waterside system 200 can be located within building 10 (e.g., as components of waterside system 120) or at an offsite location such as a central plant.

In FIG. 2, waterside system 200 is shown as a central plant having a plurality of subplants 202-212. Subplants 202-212 are shown to include a heater subplant 202, a heat recovery chiller subplant 204, a chiller subplant 206, a cooling tower subplant 208, a hot thermal energy storage (TES) subplant 210, and a cold thermal energy storage (TES) subplant 212. Subplants 202-212 consume resources (e.g., water, natural gas, electricity, etc.) from utilities to serve the thermal energy loads (e.g., hot water, cold water, heating, cooling, etc.) of a building or campus. For example, heater subplant 202 can be configured to heat water in a hot water loop 214 that circulates the hot water between heater subplant 202 and building 10. Chiller subplant 206 can be configured to chill water in a cold water loop 216 that circulates the cold water between chiller subplant 206 building 10. Heat recovery chiller subplant 204 can be configured to transfer heat from cold water loop 216 to hot water loop 214 to provide additional heating for the hot water and additional cooling for the cold water. Condenser water loop 218 can absorb heat from the cold water in chiller subplant 206 and reject the absorbed heat in cooling tower subplant 208 or transfer the absorbed heat to hot water loop 214. Hot TES subplant 210 and cold TES subplant 212 can store hot and cold thermal energy, respectively, for subsequent use.

Hot water loop 214 and cold water loop 216 can deliver the heated and/or chilled water to air handlers located on the rooftop of building 10 (e.g., AHU 106) or to individual floors or zones of building 10 (e.g., VAV units 116). The air handlers push air past heat exchangers (e.g., heating coils or cooling coils) through which the water flows to provide heating or cooling for the air. The heated or cooled air can be delivered to individual zones of building 10 to serve the thermal energy loads of building 10. The water then returns to subplants 202-212 to receive further heating or cooling.

Although subplants 202-212 are shown and described as heating and cooling water for circulation to a building, it is understood that any other type of working fluid (e.g., glycol, CO2, etc.) can be used in place of or in addition to water to serve the thermal energy loads. In other embodiments, subplants 202-212 can provide heating and/or cooling directly to the building or campus without requiring an intermediate heat transfer fluid. These and other variations to waterside system 200 are within the teachings of the present invention.

Each of subplants 202-212 can include a variety of equipment configured to facilitate the functions of the subplant. For example, heater subplant 202 is shown to include a plurality of heating elements 220 (e.g., boilers, electric heaters, etc.) configured to add heat to the hot water in hot water loop 214. Heater subplant 202 is also shown to include several pumps 222 and 224 configured to circulate the hot water in hot water loop 214 and to control the flow rate of the hot water through individual heating elements 220. Chiller subplant 206 is shown to include a plurality of chillers 232 configured to remove heat from the cold water in cold water loop 216. Chiller subplant 206 is also shown to include several pumps 234 and 236 configured to circulate the cold water in cold water loop 216 and to control the flow rate of the cold water through individual chillers 232.

Heat recovery chiller subplant 204 is shown to include a plurality of heat recovery heat exchangers 226 (e.g., refrigeration circuits) configured to transfer heat from cold water loop 216 to hot water loop 214. Heat recovery chiller subplant 204 is also shown to include several pumps 228 and 230 configured to circulate the hot water and/or cold water through heat recovery heat exchangers 226 and to control the flow rate of the water through individual heat recovery heat exchangers 226. Cooling tower subplant 208 is shown to include a plurality of cooling towers 238 configured to remove heat from the condenser water in condenser water loop 218. Cooling tower subplant 208 is also shown to include several pumps 240 configured to circulate the condenser water in condenser water loop 218 and to control the flow rate of the condenser water through individual cooling towers 238.

Hot TES subplant 210 is shown to include a hot TES tank 242 configured to store the hot water for later use. Hot TES subplant 210 can also include one or more pumps or valves configured to control the flow rate of the hot water into or out of hot TES tank 242. Cold TES subplant 212 is shown to include cold TES tanks 244 configured to store the cold water for later use. Cold TES subplant 212 can also include one or more pumps or valves configured to control the flow rate of the cold water into or out of cold TES tanks 244.

In some embodiments, one or more of the pumps in waterside system 200 (e.g., pumps 222, 224, 228, 230, 234, 236, and/or 240) or pipelines in waterside system 200 include an isolation valve associated therewith. Isolation valves can be integrated with the pumps or positioned upstream or downstream of the pumps to control the fluid flows in waterside system 200. In various embodiments, waterside system 200 can include more, fewer, or different types of devices and/or subplants based on the particular configuration of waterside system 200 and the types of loads served by waterside system 200.

Referring now to FIG. 3, a block diagram of an airside system 300 is shown, according to an exemplary embodiment. In various embodiments, airside system 300 can supplement or replace airside system 130 in HVAC system 100 or can be implemented separate from HVAC system 100. When implemented in HVAC system 100, airside system 300 can include a subset of the HVAC devices in HVAC system 100 (e.g., AHU 106, VAV units 116, ducts 112-114, fans, dampers, etc.) and can be located in or around building 10. Airside system 300 can operate to heat or cool an airflow provided to building 10 using a heated or chilled fluid provided by waterside system 200.

In FIG. 3, airside system 300 is shown to include an economizer-type air handling unit (AHU) 302. Economizer-type AHUs vary the amount of outside air and return air used by the air handling unit for heating or cooling. For example, AHU 302 can receive return air 304 from building zone 306 via return air duct 308 and can deliver supply air 310 to building zone 306 via supply air duct 312. In some embodiments, AHU 302 is a rooftop unit located on the roof of building 10 (e.g., AHU 106 as shown in FIG. 1) or otherwise positioned to receive both return air 304 and outside air 314. AHU 302 can be configured to operate exhaust air damper 316, mixing damper 318, and outside air damper 320 to control an amount of outside air 314 and return air 304 that combine to form supply air 310. Any return air 304 that does not pass through mixing damper 318 can be exhausted from AHU 302 through exhaust damper 316 as exhaust air 322.

Each of dampers 316-320 can be operated by an actuator. For example, exhaust air damper 316 can be operated by actuator 324, mixing damper 318 can be operated by actuator 326, and outside air damper 320 can be operated by actuator 328. Actuators 324-328 can communicate with an AHU controller 330 via a communications link 332. Actuators 324-328 can receive control signals from AHU controller 330 and can provide feedback signals to AHU controller 330. Feedback signals can include, for example, an indication of a current actuator or damper position, an amount of torque or force exerted by the actuator, diagnostic information (e.g., results of diagnostic tests performed by actuators 324-328), status information, commissioning information, configuration settings, calibration data, and/or other types of information or data that can be collected, stored, or used by actuators 324-328. AHU controller 330 can be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 324-328.

Still referring to FIG. 3, AHU 302 is shown to include a cooling coil 334, a heating coil 336, and a fan 338 positioned within supply air duct 312. Fan 338 can be configured to force supply air 310 through cooling coil 334 and/or heating coil 336 and provide supply air 310 to building zone 306. AHU controller 330 can communicate with fan 338 via communications link 340 to control a flow rate of supply air 310. In some embodiments, AHU controller 330 controls an amount of heating or cooling applied to supply air 310 by modulating a speed of fan 338.

Cooling coil 334 can receive a chilled fluid from waterside system 200 (e.g., from cold water loop 216) via piping 342 and can return the chilled fluid to waterside system 200 via piping 344. Valve 346 can be positioned along piping 342 or piping 344 to control a flow rate of the chilled fluid through cooling coil 334. In some embodiments, cooling coil 334 includes multiple stages of cooling coils that can be independently activated and deactivated (e.g., by AHU controller 330, by BMS controller, etc.) to modulate an amount of cooling applied to supply air 310.

Heating coil 336 can receive a heated fluid from waterside system 200 (e.g., from hot water loop 214) via piping 348 and can return the heated fluid to waterside system 200 via piping 350. Valve 352 can be positioned along piping 348 or piping 350 to control a flow rate of the heated fluid through heating coil 336. In some embodiments, heating coil 336 includes multiple stages of heating coils that can be independently activated and deactivated (e.g., by AHU controller 330, by BMS controller, etc.) to modulate an amount of heating applied to supply air 310.

Each of valves 346 and 352 can be controlled by an actuator. For example, valve 346 can be controlled by actuator 354 and valve 352 can be controlled by actuator 356. Actuators 354-356 can communicate with AHU controller 330 via communications links 358-360. Actuators 354-356 can receive control signals from AHU controller 330 and can provide feedback signals to controller 330. In some embodiments, AHU controller 330 receives a measurement of the supply air temperature from a temperature sensor 362 positioned in supply air duct 312 (e.g., downstream of cooling coil 334 and/or heating coil 336). AHU controller 330 can also receive a measurement of the temperature of building zone 306 from a temperature sensor 364 located in building zone 306.

In some embodiments, AHU controller 330 operates valves 346 and 352 via actuators 354-356 to modulate an amount of heating or cooling provided to supply air 310 (e.g., to achieve a set-point temperature for supply air 310 or to maintain the temperature of supply air 310 within a set-point temperature range). The positions of valves 346 and 352 affect the amount of heating or cooling provided to supply air 310 by cooling coil 334 or heating coil 336 and may correlate with the amount of energy consumed to achieve a desired supply air temperature. AHU controller 330 can control the temperature of supply air 310 and/or building zone 306 by activating or deactivating coils 334-336, adjusting a speed of fan 338, or a combination of both.

Still referring to FIG. 3, airside system 300 is shown to include a building management system (BMS) controller and a client device. BMS controller can include one or more computer systems (e.g., servers, supervisory controllers, subsystem controllers, etc.) that serve as system level controllers, application or data servers, head nodes, or master controllers for airside system 300, waterside system 200, HVAC system 100, and/or other controllable systems that serve building 10. BMS controller can communicate with multiple downstream building systems or subsystems (e.g., HVAC system 100, a security system, a lighting system, waterside system 200, etc.) via a communications link according to like or disparate protocols (e.g., LON, BACnet, etc.). In various embodiments, AHU controller 330 and BMS controller can be separate (as shown in FIG. 3) or integrated. In an integrated implementation, AHU controller 330 can be a software module configured for execution by a processor of BMS controller.

In some embodiments, AHU controller 330 receives information from BMS controller (e.g., commands, set-points, operating boundaries, etc.) and provides information to BMS controller (e.g., temperature measurements, valve or actuator positions, operating statuses, diagnostics, etc.). For example, AHU controller 330 can provide BMS controller with temperature measurements from temperature sensors 362-364, equipment on/off states, equipment operating capacities, and/or any other information that can be used by BMS controller to monitor or control a variable state or condition within building zone 306.

Client device can include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 100, its subsystems, and/or devices. Client device can be a computer workstation, a client terminal, a remote or local interface, or any other type of user interface device. Client device can be a stationary terminal or a mobile device. For example, client device can be a desktop computer, a computer server with a user interface, a laptop computer, a tablet, a smartphone, a PDA, or any other type of mobile or non-mobile device. Client device can communicate with BMS controller and/or AHU controller 330 via communications link.

### Residential HVAC System

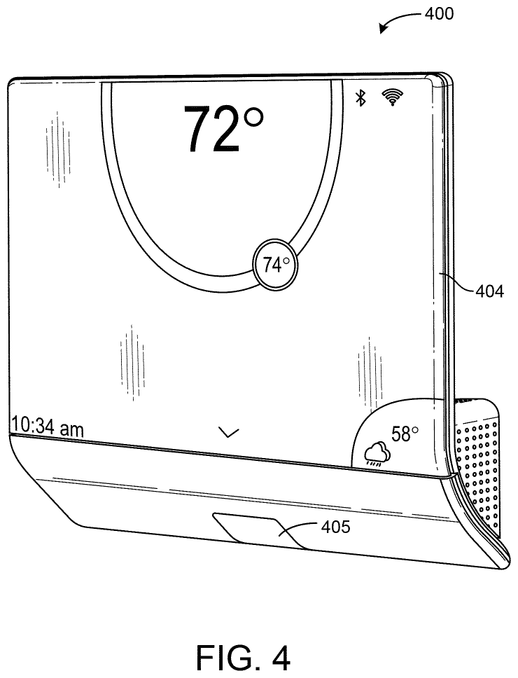

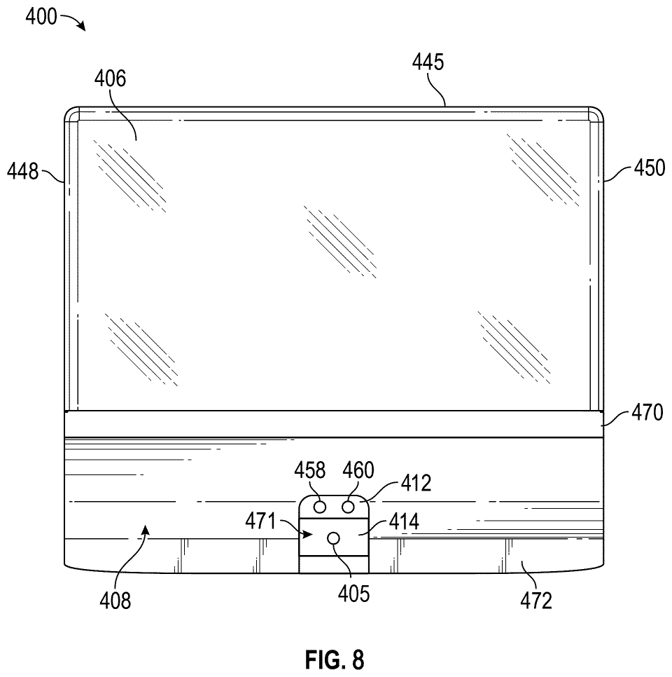

Referring now to FIG. 4, a drawing of a space controller, shown as thermostat 400 for controlling building equipment is shown, according to an exemplary embodiment. The thermostat 400 may include a variety of user interface devices (e.g., a touch-sensitive panel, an electronic display, speakers, haptic feedback, microphone, ambient lighting, etc.) configured to facilitate user interaction with the user control device. The thermostat 400 is shown to include a user interface, shown as display 404, and a camera 405 (see also FIG. 8). The display 404 may be an interactive display that can display information to a user and receive input from the user. The camera 405 can be a still or digital video camera that can capture images that may be displayed on the display 404. The display 404 may be transparent such that a user can view information on the display 404 and view the surface located behind the display 404. Thermostats with transparent and cantilevered displays are described in further detail in U.S. patent application Ser. No. 15/146,649 filed May 4, 2016, the entirety of which is incorporated by reference herein.

The display 404 can be a touchscreen or other type of electronic display configured to present information to a user in a visual format (e.g., as text, graphics, etc.) and receive input from a user (e.g., via a touch-sensitive panel). For example, the display 404 may include a touch-sensitive panel layered on top of an electronic visual display. A user can provide inputs through simple or multi-touch gestures by touching the display 404 with one or more fingers and/or with a stylus or pen. The display 404 can use any of a variety of touch-sensing technologies to receive user inputs, such as capacitive sensing (e.g., surface capacitance, projected capacitance, mutual capacitance, self-capacitance, etc.), resistive sensing, surface acoustic wave, infrared grid, infrared acrylic projection, optical imaging, dispersive signal technology, acoustic pulse recognition, or other touch-sensitive technologies known in the art. Many of these technologies allow for multi-touch responsiveness of display 404 allowing registration of touch in two or even more locations at once. The display may use any of a variety of display technologies such as light emitting diode (LED), organic light-emitting diode (OLED), liquid-crystal display (LCD), organic light-emitting transistor (OLET), surface-conduction electron-emitter display (SED), field emission display (FED), digital light processing (DLP), liquid crystal on silicon (LCoC), or any other display technologies known in the art. In some embodiments, the display 404 is configured to present visual media (e.g., text, graphics, etc.) without requiring a backlight.

The camera 405 can be a complementary metal-oxide-semiconductor (CMOS) or other type of camera configured to capture images from the environment. In some embodiments, the camera 405 may be an infrared camera configured to provide image sensing in low-light conditions. The camera 405 can be adjustable relative to the display 404 so that the camera 405 can be repositioned (e.g., angled in different directions) to focus on an intended subject. A user can provide inputs through simple or multi-touch gestures through the display 404 to control the camera 405 (e.g., to control the angle of the camera 405, to refocus the camera 405, to zoom in, etc.). The thermostat 400 may also include an ambient light sensor configured to sense ambient light levels, and the camera 405 can activate or operate in a different mode (e.g., a night vision mode, etc.) when the ambient light sensor detects light below a certain level or based on other preset conditions.

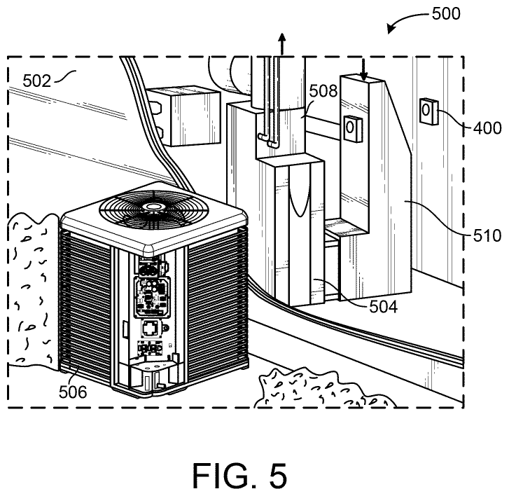

Referring now to FIG. 5, a residential heating and cooling system 500 is shown, according to an exemplary embodiment. The residential heating and cooling system 500 may provide heated and cooled air to a residential structure. Although described as a residential heating and cooling system 500, embodiments of the systems and methods described herein can be utilized in a cooling unit or a heating unit in a variety of applications include commercial HVAC units (e.g., roof top units). In general, a residence 502 includes refrigerant conduits that operatively couple an indoor unit 504 to an outdoor unit 506. Indoor unit 504 may be positioned in a utility space, an attic, a basement, and so forth. Outdoor unit 506 is situated adjacent to a side of residence 502. Refrigerant conduits transfer refrigerant between indoor unit 504 and outdoor unit 506, typically transferring primarily liquid refrigerant in one direction and primarily vaporized refrigerant in an opposite direction.

When the system 500 shown in FIG. 5 is operating as an air conditioner, a coil in outdoor unit 506 serves as a condenser for recondensing vaporized refrigerant flowing from indoor unit 504 to outdoor unit 506 via one of the refrigerant conduits. In these applications, a coil of the indoor unit 504, designated by the reference numeral 508, serves as an evaporator coil. Evaporator coil 508 receives liquid refrigerant (which may be expanded by an expansion device, not shown) and evaporates the refrigerant before returning it to outdoor unit 506.

Outdoor unit 506 draws in environmental air through its sides, forces the air through the outer unit coil using a fan, and expels the air. When operating as an air conditioner, the air is heated by the condenser coil within the outdoor unit 506 and exits the top of the unit at a temperature higher than it entered the sides. Air is blown over indoor coil 508 and is then circulated through residence 502 by means of ductwork 510, as indicated by the arrows entering and exiting ductwork 510. The overall system 500 operates to maintain a desired temperature as set by thermostat 400. When the temperature sensed inside the residence 502 is higher than the set point on the thermostat 400 (with the addition of a relatively small tolerance), the air conditioner will become operative to refrigerate additional air for circulation through the residence 502. When the temperature reaches the set point (with the removal of a relatively small tolerance), the unit can stop the refrigeration cycle temporarily.

In some embodiments, the system 500 configured so that the outdoor unit 506 is controlled to achieve a more elegant control over temperature and humidity within the residence 502. The outdoor unit 506 is controlled to operate components within the outdoor unit 506, and the system 500, based on a percentage of a delta between a minimum operating value of the compressor and a maximum operating value of the compressor plus the minimum operating value. In some embodiments, the minimum operating value and the maximum operating value are based on the determined outdoor ambient temperature, and the percentage of the delta is based on a predefined temperature differential multiplier and one or more time dependent multipliers.

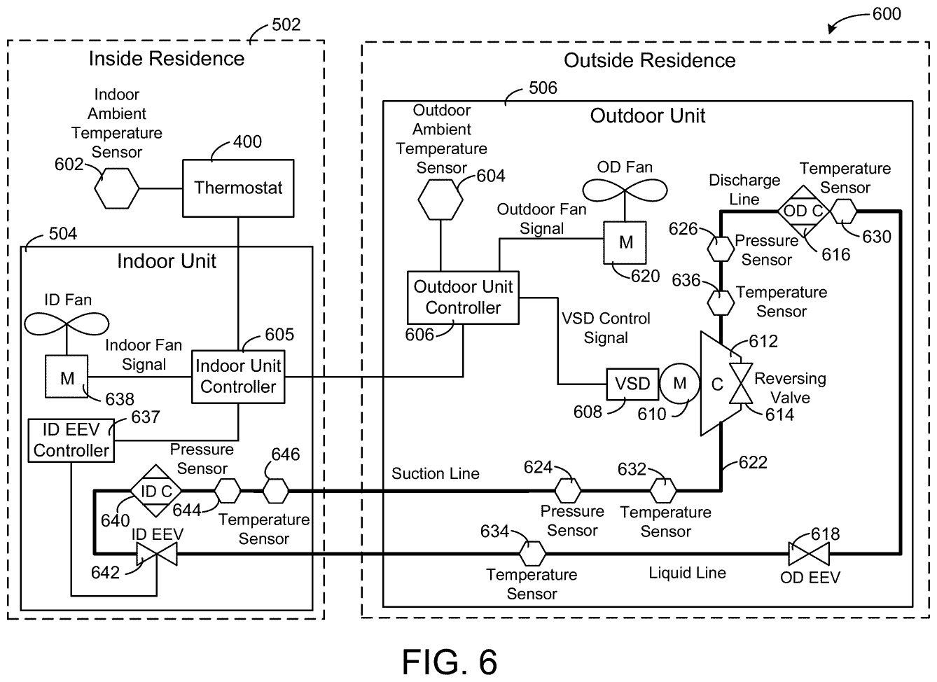

Referring now to FIG. 6, an HVAC system 600 is shown according to an exemplary embodiment. Various components of system 600 are located inside residence 502 while other components are located outside residence 502. Outdoor unit 506, as described with reference to FIG. 5, is shown to be located outside residence 502 while indoor unit 504 and thermostat 400, as described with reference to FIG. 6, are shown to be located inside the residence 502. In various embodiments, the thermostat 400 can cause the indoor unit 506 and the outdoor unit 504 to heat residence 502. In some embodiments, the thermostat 400 can cause the indoor unit 504 and the outdoor unit 506 to cool the residence 502. In other embodiments, the thermostat 400 can command an airflow change within the residence 502 to adjust the humidity within the residence 502.

Thermostat 400 can be configured to generate control signals for indoor unit 504 and/or outdoor unit 506. The thermostat 400 is shown to be connected to an indoor ambient temperature sensor 602, and an outdoor unit controller 606 is shown to be connected to an outdoor ambient temperature sensor 604. The indoor ambient temperature sensor 602 and the outdoor ambient temperature sensor 604 may be any kind of temperature sensor (e.g., thermistor, thermocouple, etc.). The thermostat 400 may measure the temperature of residence 502 via the indoor ambient temperature sensor 602. Further, the thermostat 400 can be configured to receive the temperature outside residence 502 via communication with the outdoor unit controller 606. In various embodiments, the thermostat 400 generates control signals for the indoor unit 504 and the outdoor unit 506 based on the indoor ambient temperature (e.g., measured via indoor ambient temperature sensor 602), the outdoor temperature (e.g., measured via the outdoor ambient temperature sensor 604), and/or a temperature set point.

The indoor unit 504 and the outdoor unit 506 may be electrically connected. Further, indoor unit 28 and outdoor unit 504 may be coupled via conduits 622. The outdoor unit 506 can be configured to compress refrigerant inside conduits 622 to either heat or cool the building based on the operating mode of the indoor unit 504 and the outdoor unit 506 (e.g., heat pump operation or air conditioning operation). The refrigerant inside conduits 622 may be any fluid that absorbs and extracts heat. For example, the refrigerant may be hydro fluorocarbon (HFC) based R-410A, R-407C, and/or R-134a.

The outdoor unit 506 is shown to include the outdoor unit controller 606, a variable speed drive 608, a motor 610 and a compressor 612. The outdoor unit 506 can be configured to control the compressor 612 and to further cause the compressor 612 to compress the refrigerant inside conduits 622. In this regard, the compressor 612 may be driven by the variable speed drive 608 and the motor 610. For example, the outdoor unit controller 606 can generate control signals for the variable speed drive 608. The variable speed drive 608 (e.g., an inverter, a variable frequency drive, etc.) may be an AC-AC inverter, a DC-AC inverter, and/or any other type of inverter. The variable speed drive 608 can be configured to vary the torque and/or speed of the motor 610 which in turn drives the speed and/or torque of compressor 612. The compressor 612 may be any suitable compressor such as a screw compressor, a reciprocating compressor, a rotary compressor, a swing link compressor, a scroll compressor, or a turbine compressor, etc.

In some embodiments, the outdoor unit controller 606 is configured to process data received from the thermostat 400 to determine operating values for components of the system 600, such as the compressor 612. In one embodiment, the outdoor unit controller 606 is configured to provide the determined operating values for the compressor 612 to the variable speed drive 608, which controls a speed of the compressor 612. The outdoor unit controller 606 is controlled to operate components within the outdoor unit 506, and the indoor unit 504, based on a percentage of a delta between a minimum operating value of the compressor and a maximum operating value of the compressor plus the minimum operating value. In some embodiments, the minimum operating value and the maximum operating value are based on the determined outdoor ambient temperature, and the percentage of the delta is based on a predefined temperature differential multiplier and one or more time dependent multipliers.

In some embodiments, the outdoor unit controller 606 can control a reversing valve 614 to operate system 600 as a heat pump or an air conditioner. For example, the outdoor unit controller 606 may cause reversing valve 614 to direct compressed refrigerant to the indoor coil 508 while in heat pump mode and to an outdoor coil 616 while in air conditioner mode. In this regard, the indoor coil 508 and the outdoor coil 616 can both act as condensers and evaporators depending on the operating mode (i.e., heat pump or air conditioner) of system 600.

Further, in various embodiments, outdoor unit controller 606 can be configured to control and/or receive data from an outdoor electronic expansion valve (EEV) 618. The outdoor electronic expansion valve 618 may be an expansion valve controlled by a stepper motor. In this regard, the outdoor unit controller 606 can be configured to generate a step signal (e.g., a PWM signal) for the outdoor electronic expansion valve 618. Based on the step signal, the outdoor electronic expansion valve 618 can be held fully open, fully closed, partial open, etc. In various embodiments, the outdoor unit controller 606 can be configured to generate step signal for the outdoor electronic expansion valve 618 based on a subcool and/or superheat value calculated from various temperatures and pressures measured in system 600. In one embodiment, the outdoor unit controller 606 is configured to control the position of the outdoor electronic expansion valve 618 based on a percentage of a delta between a minimum operating value of the compressor and a maximum operating value of the compressor plus the minimum operating value. In some embodiments, the minimum operating value and the maximum operating value are based on the determined outdoor ambient temperature, and the percentage of the delta is based on a predefined temperature differential multiplier and one or more time dependent multipliers.

The outdoor unit controller 606 can be configured to control and/or power outdoor fan 620. The outdoor fan 620 can be configured to blow air over the outdoor coil 616. In this regard, the outdoor unit controller 606 can control the amount of air blowing over the outdoor coil 616 by generating control signals to control the speed and/or torque of outdoor fan 620. In some embodiments, the control signals are pulse wave modulated signals (PWM), analog voltage signals (i.e., varying the amplitude of a DC or AC signal), and/or any other type of signal. In one embodiment, the outdoor unit controller 606 can control an operating value of the outdoor fan 620, such as speed, based on a percentage of a delta between a minimum operating value of the compressor and a maximum operating value of the compressor plus the minimum operating value. In some embodiments, the minimum operating value and the maximum operating value are based on the determined outdoor ambient temperature, and the percentage of the delta is based on a predefined temperature differential multiplier and one or more time dependent multipliers.

The outdoor unit 506 may include one or more temperature sensors and one or more pressure sensors. The temperature sensors and pressure sensors may be electrical connected (i.e., via wires, via wireless communication, etc.) to the outdoor unit controller 606. In this regard, the outdoor unit controller 606 can be configured to measure and store the temperatures and pressures of the refrigerant at various locations of the conduits 622. The pressure sensors may be any kind of transducer that can be configured to sense the pressure of the refrigerant in the conduits 622. The outdoor unit 506 is shown to include pressure sensor 624. The pressure sensor 624 may measure the pressure of the refrigerant in conduit 622 in the suction line (i.e., a predefined distance from the inlet of compressor 612). Further, the outdoor unit 506 is shown to include pressure sensor 626. The pressure sensor 626 may be configured to measure the pressure of the refrigerant in conduits 622 on the discharge line (e.g., a predefined distance from the outlet of compressor 612).

The temperature sensors of outdoor unit 506 may include thermistors, thermocouples, and/or any other temperature sensing device. The outdoor unit 506 is shown to include temperature sensor 630, temperature sensor 632, temperature sensor 634, and temperature sensor 636. The temperature sensors (i.e., temperature sensor 630, temperature sensor 632, temperature sensor 634, and/or temperature sensor 636) can be configured to measure the temperature of the refrigerant at various locations inside conduits 622.

Referring now to the indoor unit 504, the indoor unit 504 is shown to include indoor unit controller 605, indoor electronic expansion valve controller 637, an indoor fan 638, an indoor coil 640, an indoor electronic expansion valve 642, a pressure sensor 644, and a temperature sensor 646. The indoor unit controller 605 can be configured to generate control signals for indoor electronic expansion valve controller 637. The signals may be set points (e.g., temperature set point, pressure set point, superheat set point, subcool set point, step value set point, etc.). In this regard, indoor electronic expansion valve controller 637 can be configured to generate control signals for indoor electronic expansion valve 642. In various embodiments, indoor electronic expansion valve 642 may be the same type of valve as outdoor electronic expansion valve 618. In this regard, indoor electronic expansion valve controller 637 can be configured to generate a step control signal (e.g., a PWM wave) for controlling the stepper motor of the indoor electronic expansion valve 642. In this regard, indoor electronic expansion valve controller 637 can be configured to fully open, fully close, or partially close the indoor electronic expansion valve 642 based on the step signal.

Indoor unit controller 605 can be configured to control indoor fan 638. The indoor fan 638 can be configured to blow air over indoor coil 640. In this regard, the indoor unit controller 605 can control the amount of air blowing over the indoor coil 640 by generating control signals to control the speed and/or torque of the indoor fan 638. In some embodiments, the control signals are pulse wave modulated signals (PWM), analog voltage signals (i.e., varying the amplitude of a DC or AC signal), and/or any other type of signal. In one embodiment, the indoor unit controller 605 may receive a signal from the outdoor unit controller indicating one or more operating values, such as speed for the indoor fan 638. In one embodiment, the operating value associated with the indoor fan 638 is an airflow, such as cubic feet per minute (CFM). In one embodiment, the outdoor unit controller 606 may determine the operating value of the indoor fan based on a percentage of a delta between a minimum operating value of the compressor and a maximum operating value of the compressor plus the minimum operating value. In some embodiments, the minimum operating value and the maximum operating value are based on the determined outdoor ambient temperature, and the percentage of the delta is based on a predefined temperature differential multiplier and one or more time dependent multipliers.

The indoor unit controller 605 may be electrically connected (e.g., wired connection, wireless connection, etc.) to pressure sensor 644 and/or temperature sensor 646. In this regard, the indoor unit controller 605 can take pressure and/or temperature sensing measurements via pressure sensor 644 and/or temperature sensor 646. In one embodiment, pressure sensor 644 and temperature sensor 646 are located on the suction line (i.e., a predefined distance from indoor coil 640). In other embodiments, the pressure sensor 644 and/or the temperature sensor 646 may be located on the liquid line (i.e., a predefined distance from indoor coil 640).

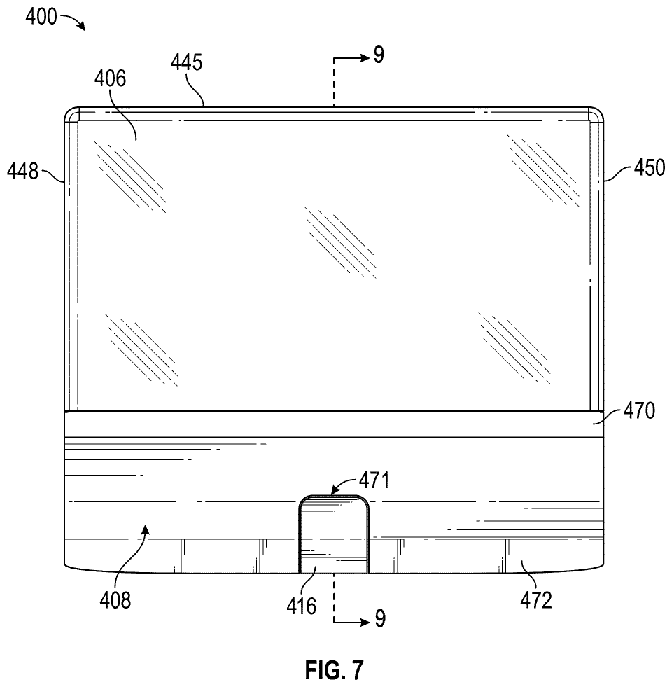

FIGS. 7-10 show various views of the thermostat 400 of FIG. 4, according to an illustrative embodiment. The thermostat 400 is configured to be mounted on a wall (e.g., a vertical wall within a dwelling, home, building, etc.) or other suitable mounting location (e.g., a ledge, a control panel, or other surface of an object within a building space, etc.).

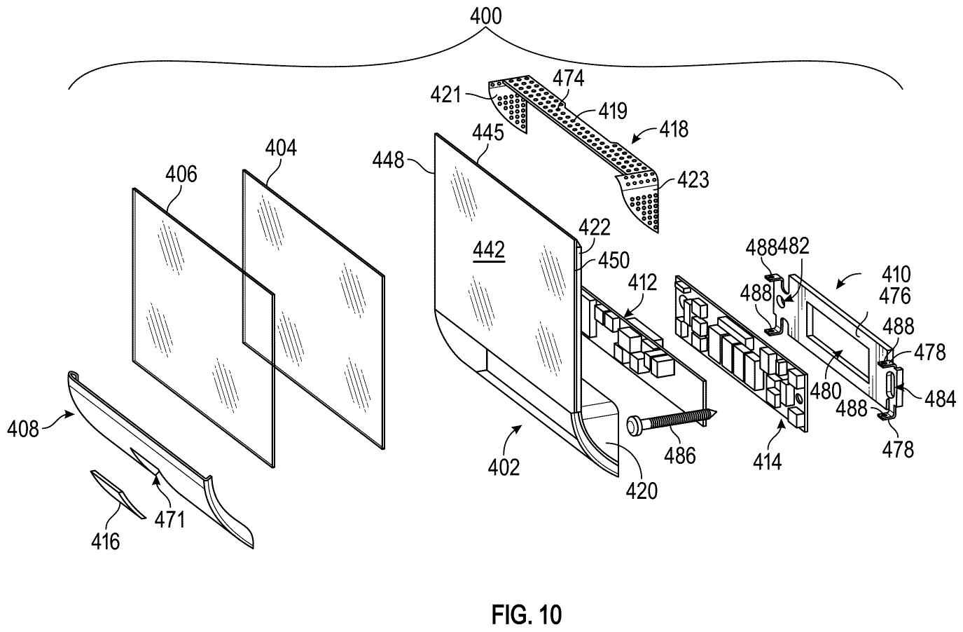

As shown in FIG. 10, the thermostat 400 includes a housing 402, a touch-sensitive display 404, a protective cover 406 for the display 404, a face plate or front cover 408, a back plate or mounting plate 410, one or more circuit boards, shown as circuit board 412 and circuit board 414, a camera lens or window 416, and a molding or top cover 418 that covers a portion of the housing 402. The assembled components of the thermostat 400 other than the mounting plate 410 and any fastener or other components used to fasten the mounting plate to the mounting location are referred to as the “thermostat body.”

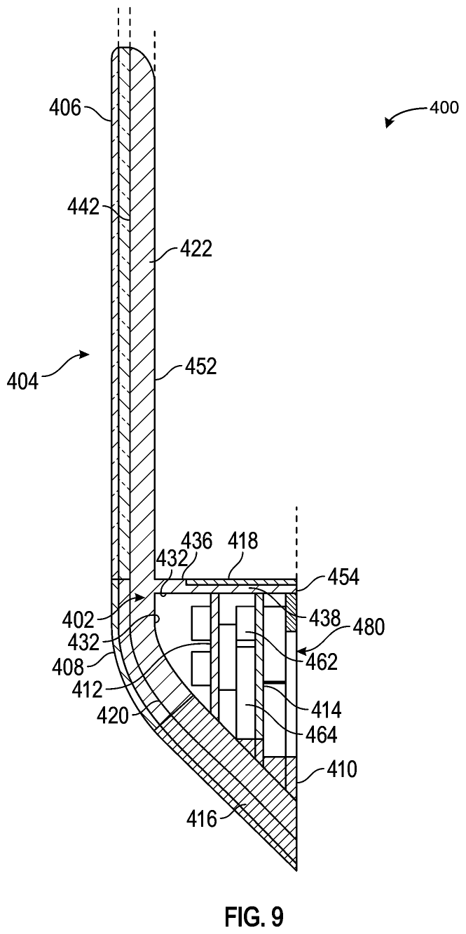

As shown in FIG. 9 (see also FIG. 10), the top wall 432 of the base 420 has two sections 436 and 438 with section 438 recessed from section 436 (e.g., thinner, having a smaller vertical dimension, having a smaller height, etc.). The section 438 receives a portion of the top cover 418 so that the top surface of the top cover 418 is flush with the top surface of the section 436 of the top wall 432.

As illustrated, the display mount 422 extends upwardly in a cantilevered fashion from the base 420 so that the display mount 422 is located above the base in the normal operating position of the thermostat 400. In alternative embodiments, the display mount 422 extends downwardly in a cantilevered fashion from the base 420 so that the display mount 422 is located below the base 420 in the normal operating position of the thermostat 400. In alternative embodiments, the display mount 422 extends sideways in a cantilevered fashion from the base 420 so that the display mount 422 is located even with and to one side of the base 420 in the normal operating position of the thermostat 400. In other embodiments, another housing configuration may be used that does not include a cantilevered display configuration.

The display mount 422 may be configured as a landscape display with the width greater than the height, as a portrait display with the width less than the height, or as a square display with the width equal to the height. The top surface of the top wall 432 and the top side 445 of the display mount 422 are parallel to one another. The left side 448 and the right side 450 are parallel to one another. The mounting surface 442 and the back surface 452 are parallel to one another. The top side 445 is perpendicular to the left side 448 and the right side 450. In some embodiments, the display mount 422 is arranged with the four sides not arranged in a rectangle or square (e.g., a parallelogram, a rhombus, a trapezoid, etc.) in shapes with more or fewer than four sides (e.g., a triangle, a pentagon, a hexagon, etc.), as a circle, as an oval or ellipse, or other shape suitable for mounting a display.

As shown in FIG. 9, the touch-sensitive display 404 is attached to the mounting surface 442 of the display mount 422 (e.g., by adhesive or other appropriate fastening techniques). The protective cover 406 is attached to front surface of the display 404 to protect the display 404 from impacts and other damage. The protective cover 406 is transparent so as to not impair the display function of the touch-sensitive display 404. In some embodiments, the protective cover 406 is omitted. In other embodiments, the protective cover is an integral component of the display 404.

As shown in FIGS. 9 and 10, in the illustrated embodiment, the housing 402 is a single integrally formed component that includes both the base 420 and the display mount 422. Forming the housing 402 as a single integral component helps the thermostat 400 withstand the torque applied about the connecting point between the display mount 422 and the base 420 when a user pushes on the touch-sensitive display 404. The relatively large thickness of the display mount 422 also helps withstand this torque.

As shown in FIGS. 9 and 10, the touch-sensitive display 404 may be a touchscreen or other type of electronic display configured to present information to a user in a visual format (e.g., as text, graphics, etc.) and receive input from a user (e.g., via a touch-sensitive panel). For example, the touch-sensitive display 404 may include a touch-sensitive panel layered on top of an electronic visual display. A user can provide inputs through simple or multi-touch gestures by touching the display 404 with one or more fingers and/or with a stylus or pen. The touch-sensitive display 404 can use any of a variety of touch-sensing technologies to receive user inputs, such as capacitive sensing (e.g., surface capacitance, projected capacitance, mutual capacitance, self-capacitance, etc.), resistive sensing, surface acoustic wave, infrared grid, infrared acrylic projection, optical imaging, dispersive signal technology, acoustic pulse recognition, or other touch-sensitive technologies known in the art. Many of these technologies allow for multi-touch responsiveness of display 404 allowing registration of touch in two or even more locations at once. The display may use any of a variety of display technologies such as light emitting diode (LED), organic light-emitting diode (OLED), liquid-crystal display (LCD), organic light-emitting transistor (OLET), surface-conduction electron-emitter display (SED), field emission display (FED), digital light processing (DLP), liquid crystal on silicon (LCoC), or any other display technologies known in the art. In some embodiments, the touch-sensitive display 404 is configured to present visual media (e.g., text, graphics, etc.) without requiring a backlight.

As shown in FIG. 10, the touch-sensitive display 404, the protective cover 406, and the display mount 422 (collectively, the “display assembly”) are not opaque, which allows the surface behind display assembly to be seen through the display assembly by a user operating or observing the thermostat 400. In embodiments omitting the protective cover 406 or in which a protective cover is an integral component of the touch-sensitive display 404, the “display assembly” consists of the touch-sensitive display 404 and the display mount 422. Not opaque means that at least some visible light is able to pass through the component and includes transparent and translucent components. For example, when the thermostat 400 is mounted on a wall, the wall is visible through the display assembly. This allows the thermostat to blend in to its surroundings when not in use (e.g. when no visual media is being displayed on the touch screen display). In the illustrated embodiment, the entire housing 402 is not opaque. In other embodiments, only the display mount 422 portion of the housing is not opaque. The housing 402 may be formed from a variety of materials (e.g., polymers including acrylics, metals, composite materials, laminates, etc.)

As shown in FIGS. 9 and 10, the housing 402 may contain various electronic components, including one or more sensors (e.g., a sensor array), one or more monitoring devices configured to generate data including at least one of sound or images, components configured to perform control functions (e.g., circuit boards, processing circuits, memory, a processor, etc.), components configured to facilitate communications (e.g., a WiFi transceiver, a cellular transceiver, a communications interface, etc.), and components configured to provide a visual display via the touch-sensitive display 404 (e.g., a video card or module, etc.).

The sensors may be coupled to the housing 402 and configured to generate sensor data that is indicative of a condition of an environment surrounding the housing 402. For example, the sensors may include a temperature sensor, a humidity sensor, an air quality sensor (e.g., carbon monoxide, carbon dioxide, allergens, smoke, etc.), a motion or occupancy sensor (e.g., a passive infrared sensor), a proximity sensor (e.g., a thermopile to detect the presence of a human and/or NFC, RFID, Bluetooth, sensors to detect the presence of a mobile device, etc.), an infrared sensor, a light sensor, a vibration sensor, or any other type of sensor configured to measure a variable state or condition of the environment in which the thermostat 400 is installed. In some embodiments, the proximity sensor is used to turn on the display 404 to present visual media when the user is close to the thermostat 400 and turn off the display 404 when the user is not close to the thermostat 400, leading to less power usage and longer display life.

The monitoring device may be communicably coupled to the thermostat 400 (e.g., space controller) and configured to generate data including at least one of sound or images. The monitoring device may include a camera (e.g., a visible light camera, an infrared camera, a night-vision camera, etc.), a microphone, or another sound or visual monitor. Some sensors and/or monitoring devices such as a proximity sensor, a motion sensor, a camera, an infrared sensor, a light sensor, or an optical sensor may positioned within the housing 402 to monitor the space near the thermostat 400 through the camera lens 416. The lens 416 is not opaque and allows at least the frequencies of light necessary for the particular sensor to function to pass therethrough, allowing the sensor and/or monitoring device to “see” or “look” through the lens 416.

In some embodiments, the display 404 may be configured to display the data from the sensor and/or monitoring device (e.g., motion sensor, camera, infrared sensor, light sensor, and/or optical sensor) onboard the thermostat 400 in real time. For example, the thermostat 400 may be used as a video conferencing device, an in-home monitor, or an intercom.

In other embodiments, one or more sensors and/or monitoring devices may be located external to the housing 402 and may provide input to the thermostat 400 via a data communications link. For example, one or more sensors may be installed in a gang box behind the thermostat 400, installed in a separate gang box mounted within the same wall to which the thermostat 400 is mounted, or otherwise located throughout the room or space monitored or controlled by the thermostat 400 (e.g., in a wall, in a ceiling panel, in an open volume of the room or space, in a duct providing airflow to the room or space or receiving airflow from the room or space, etc.). This allows the thermostat 400 to monitor the input from a variety of sensors positioned at disparate locations. For example, a humidity sensor may be positioned in a wall and configured to measure the humidity within the wall (e.g., to detect water leakage or burst pipes). In another example, a camera may be located in rooms or spaces that are not otherwise monitored by the thermostat 400 but that would benefit from visual monitoring such as a nursey, an elderly individual's bedroom, etc. The image from the camera may be received by the thermostat 400 and may then be viewed on the display 404 of the thermostat 400.

In other embodiments, the images and data from the monitoring device(s) in the thermostat 400 and/or the monitoring device(s) located external to the housing 402 may be sent to a network (e.g., cloud) where they are accessible by other network connected devices. The thermostat 400 may also incorporate various security/privacy devices to prevent unwanted access to livestream images, video, and data produced by the monitoring devices. For example, the thermostat 400 may include a physical shutter as part of the camera lens 416 or other means of privacy control so that a user may inhibit the camera 405 (see also FIG. 8) of the thermostat 400 from capturing images under certain conditions (e.g., a separate password may be required once connected to the thermostat 400 to open the shutter and enable the various functions of the camera 405). In other embodiments, access to the monitoring device(s) may involve facial recognition or passphrases input by the user into the thermostat 400 to enable the monitoring device(s) to function.

As shown in FIGS. 8 and 9, the circuit boards 412 and 414 may include one or more sensors (e.g., a temperature sensor, a humidity sensor, etc.), monitoring devices, communications electronics, a processing circuit, and/or other electronics configured to facilitate the functions of the thermostat 400. As shown in FIG. 9, the circuit boards 412 and 414 are oriented substantially parallel to the display mount 422 and the rear face 454 of the base 420. The circuit boards 412 and 414 may be spaced apart from one another in a direction perpendicular to the display mount 422 and the rear face 454. In other embodiments, one or both of the circuit boards 412 and 414 may be oriented substantially perpendicular to the display mount 422 and the rear face 454.

In some embodiments, the circuit board 412 functions at least in part as a sensor board and has one or more sensors, including a proximity sensor 458, a motion or occupancy sensor 460, and a temperature sensor 462. In some embodiments, the circuit board 414 functions at least in part as control board and includes processing electronics 464 (e.g., a processing circuit), a power supply or battery, and input terminals (not shown) for receiving wiring from the HVAC system to be controlled by the thermostat 400. The processing electronics 464 are coupled (e.g., by a cable or wiring harness) to the touch-sensitive display 404 to receive user inputs from the display 404 and provide outputs to control the display 404 to control operation of the display 404. In some embodiments, the power supply is rechargeable. In some embodiments, the power supply can be replaced by the user. The processing electronics can include a processor and memory device. Processor can be implemented as a general purpose processor, an application specific integrated circuit (ASIC), one or more field programmable gate arrays (FPGAs), a group of processing components, or other suitable electronic processing components. Memory device (e.g., memory, memory unit, storage device, etc.) is one or more devices (e.g., RAM, ROM, Flash memory, hard disk storage, etc.) for storing data and/or computer code for completing or facilitating the various processes, layers and modules described in the present application. Memory device may be or include volatile memory or non-volatile memory. Memory device may include database components, object code components, script components, or any other type of information structure for supporting the various activities and information structures described in the present application. According to an exemplary embodiment, memory device is communicably connected to processor via processing circuit and includes computer code for executing (e.g., by processing circuit and/or processor) one or more processes described herein. In some embodiments, the electronic components are found on a single circuit board, are variously distributed among the two circuit boards 412 and 414, or are variously distributed among more than two circuit boards.

In the illustrated embodiment, the front cover 408 is removably attached to the housing 402 (e.g., by magnets, by a snap-fit connection, by screws or other mechanical fasteners). Removably attaching the front cover 408 allows the end-user to customize the appearance of the thermostat 400 by allowing him to select amongst front covers made of different materials or having different color or finishes. In some embodiments, the front cover 408 is attached to the housing 402 by a hinge. In some embodiments, the front cover 408 is omitted and the aperture for the sensor lens is formed in the housing. As shown in FIG. 9, the front cover 408 and the protective cover 406 combine to form a continuous or flush front surface of the thermostat 400.

As shown in FIGS. 7-8, the camera lens 416 is positioned within an aperture or opening 471 formed through the front cover 408 and through a bottom wall of the base 420 of the housing 402 (see also FIG. 9). As illustrated, the aperture 471 is three-sided with the open side located at the rear face 454 of the housing 402. This positions the lens 416 and the aperture 471 near the lower end of the front cover 408 and near the lower end of the housing 402. In some embodiments, the lens 416 and the aperture 471 are positioned near the upper end of the front cover 408 and near the upper end of the housing 402 (e.g., near the display assembly). In other embodiments, the lens 416 is positioned at another location along the housing 402 (e.g., proximate to a left side or a right side of the front cover 408, proximate to a corner of the front cover 408, etc.). The lens 416 may be secured in the aperture 471 by a friction or snap fit, adhesive, or other appropriate fastening technique. In some embodiments, the thermostat 400 includes multiple camera lenses located in corresponding apertures in the front cover 408 or in corresponding apertures in the housing 402 or the top cover 418.

As shown in FIG. 10 (see also FIG. 9), the top cover 418 is removably attached to the housing 402. The top cover 418 include a top wall 419 and two side walls 421 and 423 that are cantilevered downward form the top wall 419. The top wall 419 of the top cover 418 covers a portion of the top wall 432 of the base 420. The top cover 418 includes multiple apertures or openings 474 that allow increased air flow to the housing 402, which may aid in cooling the electronic components located within the housing 402. In the illustrated embodiment, the apertures 474 are a series of relatively small circular perforations. In other embodiments, the apertures 474 may be larger, different shapes, and/or formed as slots or louvers. The top cover 418 may be formed from a variety of materials (e.g., polymers including acrylics, metals, composite materials, laminates, etc.). In the illustrated embodiment, the top cover 418 is removably attached to the housing 402 (e.g., by magnets, by a snap-fit connection, by screws or other mechanical fasteners). Removably attaching the top cover 418 allows the end-user to customize the appearance of the thermostat 400 by allowing him to select amongst top covers made of different materials or having different color or finishes. In some embodiments, the top cover 418 is attached to the housing 402 by a hinge. In some embodiments, the top cover 418 is omitted from the thermostat 400.

As shown in FIG. 10 the mounting plate 410 includes a main portion or base 476 and four attachment tabs 478 that extend perpendicularly away from the base 476. A rear surface of the mounting plate 410 is configured to placed flush against the wall or other surface that thermostat 400 is to be mounted to. The base 476 includes an aperture or opening 480 that is and configured to allow control wiring from the HVAC system to be controlled by the thermostat 400 to pass through the mounting plate 410 and to be connected to the input terminals located within the housing 402. As illustrated, the aperture 480 is centrally located in the base 476. Two fastener apertures or openings 482 and 484 are formed through the base 476 and are spaced apart from one another. Each aperture 482 and 484 allows a screw 486 or other mechanical fastener to pass through the base 476 to attach the mounting plate 410 to a wall or other mounting location. As illustrated, the aperture 482 is circular and the aperture 484 is an elongated slot. The elongated slot allows the user to pivot the mounting plate 410 relative to the mounting holes in the wall to level the mounting plate 410 horizontally before tightening the fasteners to fix the mounting plate 410 in place on the wall. In some embodiments the apertures 482 and 484 are spaced apart by a standard thermostat mounting distance so that the thermostat 400 can be used to replace an existing thermostat without having to drill new mounting holes into the wall that the thermostat 400 is being attached to.

As shown in FIG. 10 the attachment tabs 478 are arranged to extend into a volume that is at least partially defined by the base 420 of the housing 402. Each tab 478 includes an aperture or opening 488 for receiving a screw or other fastener to attach the housing 402 to the mounting plate 410. The housing 402 includes corresponding apertures or openings (not shown) formed in the top wall 432 (see also FIG. 9) and the bottom wall to allow the fastener to extend through the housing 402 to the attachment tab. After the mounting plate 410 is attached to the wall, the thermostat body is positioned on the mounting plate 410 and the housing 402 is attached to the mounting plate 410. In some embodiments, the attachment tabs 478 are replaced by snap-fit connections, spring-biased arms, or other attachment structures suitable for attaching the housing 402 to the mounting plate 410. As shown in FIG. 9, when the housing 402 is attached to the mounting plate 410, the mounting plate 410 is positioned within the volume formed in the interior of the housing 402 with the rear surface of the mounting plate 476 (see also FIG. 10) flush with the rear face 454 of the base 420 of the housing 402. This covers the mounting plate 410 from view by an observer or user of the thermostat 400.

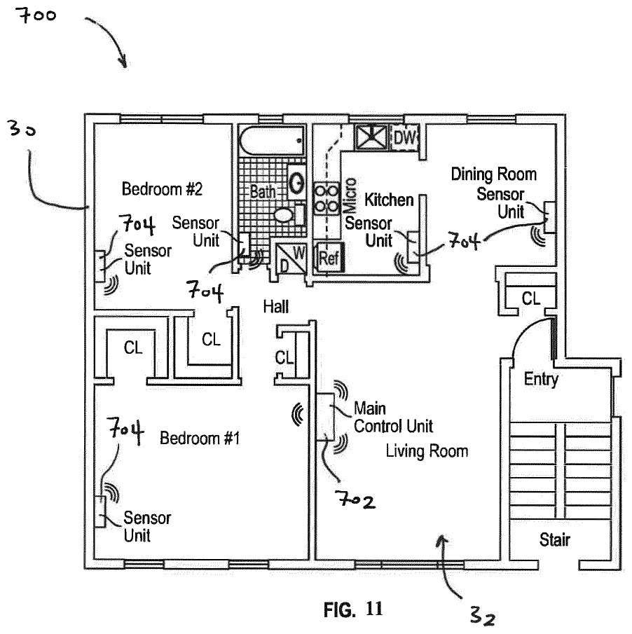

FIG. 11 is a block diagram of a building control system 700, according to an illustrative embodiment. The building control system 700 is configured to control an environmental condition of at least one space 32 within a building 30. The environmental condition may be a temperature, a humidity, an air quality, an amount of lighting, or another condition of the space 32. As shown in FIG. 11, the building control system 700 includes a space controller 702 and a plurality of sensor units 704 located remotely from the space controller 702 (e.g., in different rooms/spaces within the building, in a remote space). The space controller is communicably coupled to the sensor units 704 and is configured to receive data from the sensor units 704. The data may include sensor data indicative of the environmental condition of a remote space, data comprising at least one of sound or images, or another type of data indicative of a condition of the remote space. The space controller 702 is configured to interpret the data received from the sensor units 704 and to operate a controlled device to affect the environmental condition of the space 32 and/or the remote space where the sensor unit 704 is located. The controlled device may be HVAC equipment (e.g., a heater, an air conditioning unit, etc.) or another piece of equipment configured to modify the environmental condition of the space 32 (e.g., window blinds, fans, etc.). In some embodiments, the sensor units 704 are also configured to operate the controlled device independently from the space controller 702 (e.g., the sensor units 704 are also space controllers).

In some embodiments, the sensor units 704 and/or space controller 702 include a monitoring device and are configured to transmit images and/or sound received from the monitoring device to over a wired or wireless network (e.g., via Wi-Fi, the internet, Bluetooth, or another wireless communications protocol). For example, a sensor unit 704 located in a bedroom may be configured to transmit video (e.g., images and sound) from a camera (e.g., camera 405) over an in-home wireless network (e.g., via a wireless gateway, etc.) to the space controller 702 and/or another sensor unit 704. A user may be able to access and view the video through the display of the space controller 702. In this way, the building control system 700 is configured to provide in-home monitoring of different spaces 32 from the space controller 702 and/or other sensor units 704.

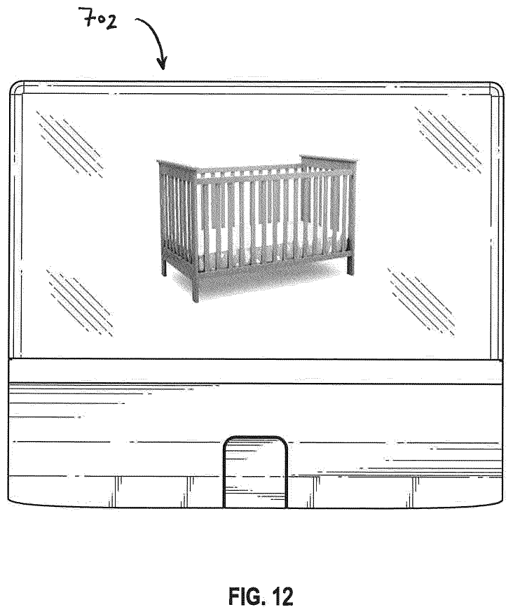

FIG. 12 illustrates the types of images and/or video that may be viewed from space controller 702 of FIG. 1. The space controller 702 is configured to display images/video from a camera positioned in a nursery (e.g., child's bedroom). The camera is directed at a child's crib so that a user may monitor the child's condition from other spaces within the building (e.g., anywhere that a sensor unit 704 and/or space controller 702 is located). Among other benefits, this functionality provides remote monitoring capabilities without requiring separate devices (e.g., baby monitors, etc.) throughout the building 30. Rather, these monitoring functions are provided by space controllers 702 and/or sensor units 704 that are already implemented throughout the building 30 as part of an environmental control system (e.g., an HVAC control system, etc.). The benefits provided by the building control system 700 are also applicable in other settings. For example, the building control system 700 may be implemented in a home of an elderly patient, nursing home, long-term care facility, a hospital, or another setting where remote monitoring may be beneficial.

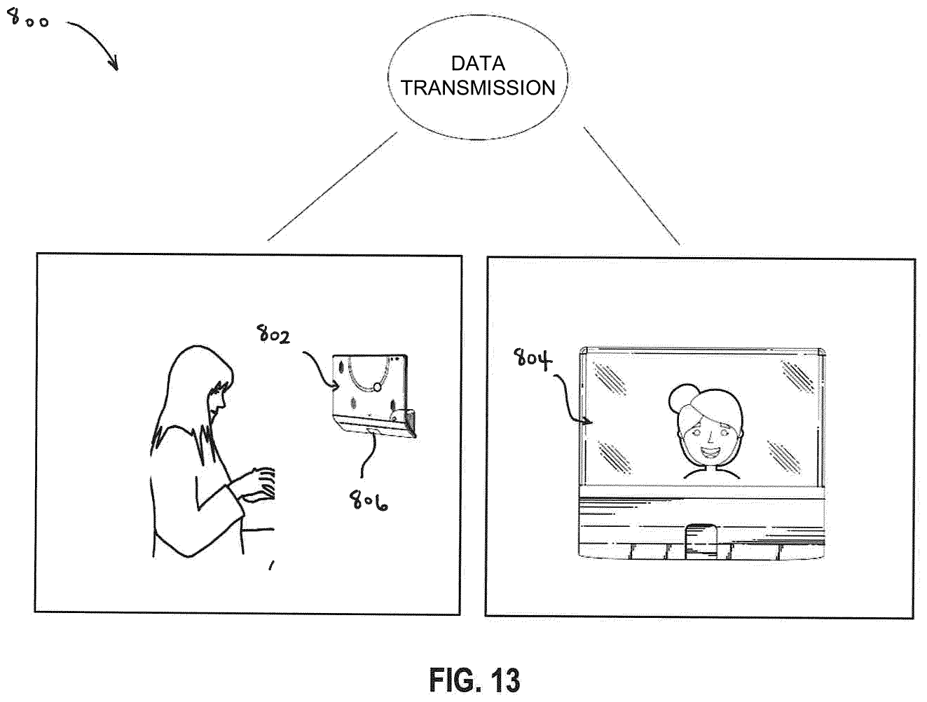

The types of data that may be transmitted between space controllers 702 and/or sensor units 704 within the building 30 are not limited to video and images. In some embodiments, the building control system 700 may also be used to transmit sound from a microphone between different spaces within a building 30. For example, FIG. 13 shows a building control system 800 that is implemented as an in-home telecommunications system. The building control system 800 allows a person located in a first space within the building 30 to communicate with a person located in a second space within the building 30 remotely from the first space. As shown in FIG. 13, the building control system 800 includes a first space controller 802 (e.g., thermostat) disposed in the first space (e.g., mounted to a wall within the first space) and a second space controller 804 disposed in the second space. The first space controller 802 includes a camera 806 and a microphone (not shown) and is configured to transmit live-stream video (e.g., real-time video) and sound data received from the camera 806 and microphone, respectively, to the second space controller 804 (e.g., to a display, speaker, etc.). The second space controller 804 is configured to display the live-stream video through the touchscreen display and to output sound through a speaker on the second space controller 804 based on the data received from the first space controller 802.

The operating parameters for the building control system may be adjusted through the user interface of the space controller and/or sensor units. For example, the user interface may present a map of the building similar to that shown in FIG. 11 to a user through the user interface. The user may select the spaces from the user interface (e.g., via the touchscreen display of the space controller 702 and/or sensor units 704 of FIG. 11, by pressing against a region of the touchscreen display that shows the desired space) that the user would like to monitor and/or communicate with via another space controller and/or sensor unit.

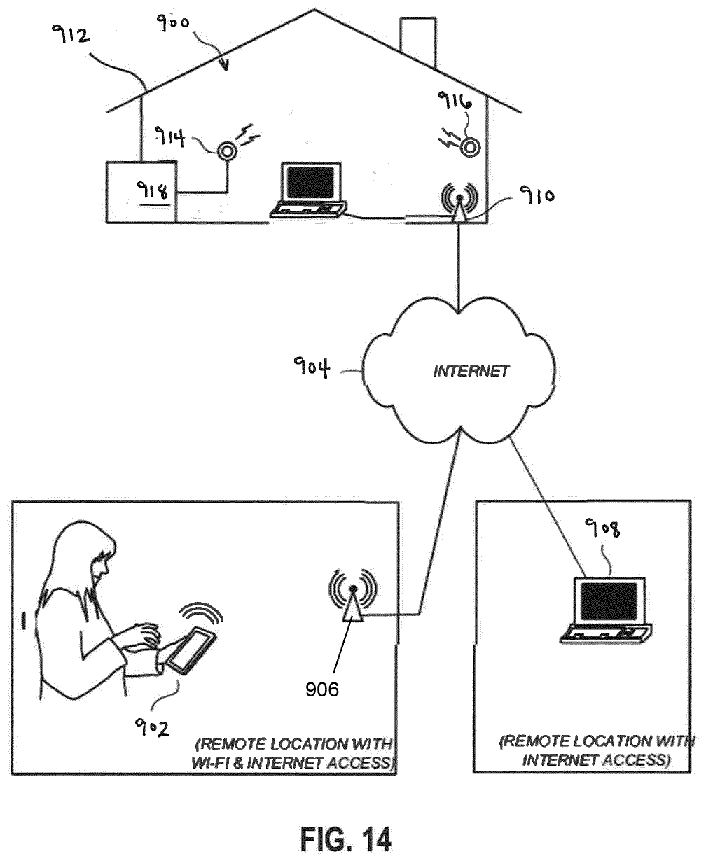

In some embodiments, the sensor unit and/or space controller may be configured to transmit data from the monitoring device over the internet (e.g., to a cloud computing device, etc.). The data may be accessed from the internet using a mobile phone, a laptop computer, or another internet connected device. The user may also configure operating parameters of the building control system through the internet (e.g., via a software application on the internet connected device, etc.). For example, FIG. 14 is a building control system 900 that is configured for remote access via an internet connected device. The internet connected device may be a mobile computer 902 (e.g., laptop, mobile phone, etc.) that is connected to the internet 904 via a wireless network 906 (e.g., a household Wi-Fi connection, a router, etc.) and/or a laptop/desktop computer 908 that is directly connected to the internet 904 (e.g., that includes a SIM card, is hardwired to the internet via a modem, etc.). As shown in FIG. 14, data transmission to and from the internet 904 and the building control system 900 is provided through a second wireless network 910, which connects various components throughout the building 912 (e.g., a space controller 914, a sensor unit 916, etc.).

In some embodiments, the building control system 900 is configured to receive commands from the internet (e.g., from the mobile computer 902 and/or the laptop/desktop computer 908, etc.) and to control the controlled device and/or monitoring device based on the commands. For example, the building control system 900 may be configured to receive commands indicative of a desired environmental condition of at least one space within the building 912. The space controller 914 may be configured to control HVAC equipment 918 and/or non-HVAC equipment based on the commands to affect the environmental condition of the at least one space. In other embodiments, the space controller 914 and/or sensor unit 916 may be configured to control the monitored device based on the commands. For example, the space controller 914 and/or sensor unit 916 may be configured to adjust a position of the camera, the size of the image provided by the camera, the sensitivity of the microphone, activation/deactivation of a night vision camera and/or infrared camera, or another monitored device operation.

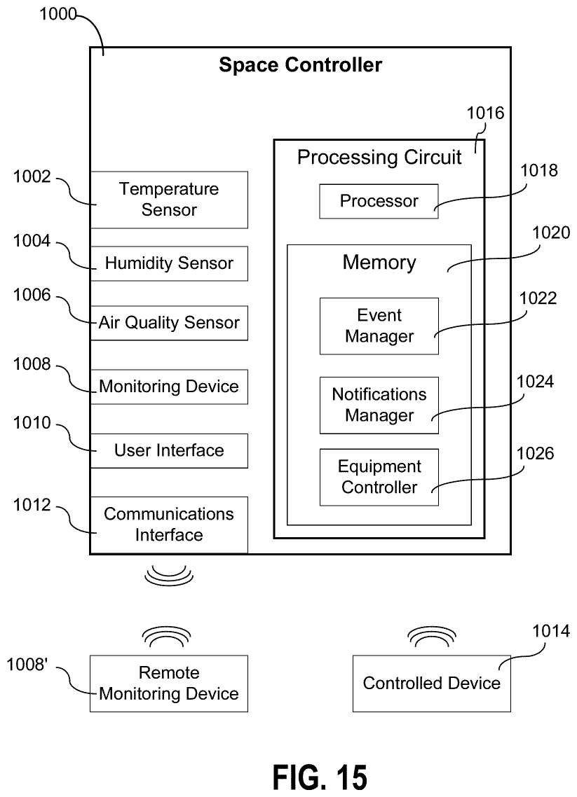

Referring now to FIG. 15, a block diagram of a space controller 1000 is shown, according to an illustrative embodiment. The space controller 1000 may be the same or similar to the space controllers 702, 802, 804, and 914 of any of FIGS. 11-15). The space controller 1000 includes a plurality of sensors onboard the space controller 1000 (e.g., contained within the same housing or enclosure as the space controller 1000). The space controller 1000 is shown to include a temperature sensor 1002 configured to measure a temperature of the environment surrounding the space controller 1000, an humidity sensor 1004 configured to determine a humidity (e.g., relative humidity, etc.) of the environment surrounding the space controller 1000, and an air quality sensor 1006 configured to determine an air quality (e.g., an amount of VOCs, CO, CO2, etc.) of the environment surrounding the space controller 1000. In other embodiments, the space controller 1000 may include additional, fewer, and/or different sensors. For example, the space controller 1000 may include any of the sensors described with reference to the thermostat 400 of FIGS. 7-9.

The space controller 1000 is also shown to include a monitoring device 1008. The monitoring device 1008 may be the same or similar to the monitoring devices described with reference to the thermostat 400 of FIGS. 9-10. The monitoring device is configured to generate data including one of sound (e.g., a person's voice, noises generated within the space in which the space controller 1000 is located, etc.) and images (e.g., pictures, etc.). The monitoring device 1008 may include a camera (e.g., a visible light camera, an infrared camera, a night-vision camera, etc.), a microphone, or another sound or visual monitor.

The space controller 1000 is also shown to include a user interface 1010, which may be the same or similar to the user interface described with reference to FIGS. 7-9. In some embodiments, the space controller 1000 is a thermostat and is configured to operate a controlled device to maintain a temperature, humidity, air quality, etc. of the space in which the thermostat is located to within a predefined range based on user preferences. For example, the user interface 1010 may be configured receive input from a user including a temperature preference. The thermostat may be configured to operate HVAC equipment to heat or cool the space to maintain a temperature of the space (e.g., the environment surrounding the housing of the space controller 1000) to within a predefined temperature range above and/or below the temperature preference.

As shown in FIG. 15, the space controller 1000 additionally includes a communications interface 1012. In various illustrative embodiments, the communications interface 1012 is configured for bi-directional communication with a network (e.g., the internet 904 of FIG. 14), other space controllers 1000, and/or sensor units (e.g., sensor units including a remote monitoring device 1008′ such as a remote camera, microphone, etc.). In other words, the communications interface 1012 is configured to both transmit data to and receive data from the network. For example, the communications interface 1012 may be configured to communicate video data, image data, sound data, and/or other information received from the monitoring device 1008 over the network. The communications interface 1012 may also be configured to communicate sensor data from the onboard sensors (e.g., the temperature sensor, humidity sensor, air quality sensor, etc.).

In some embodiments, the communications interface 1012 is also configured for bi-directional communication with a controlled device 1014. The space controller 1000 may be configured to operate the controlled device 1014 based on sensor data from any one of the plurality of onboard sensors to affect an environmental condition of the environment surrounding the space controller 1000. The space controller 1000 may also be configured to operate the controlled device 1014 based on data from the monitoring device 1008. For example, the space controller 1000 may be configured to determine an event based on the data received from the monitoring device 1008, and to operate the controlled device 1014 based on the event, as will be further described.

The space controller 1000 is shown to include a processing circuit 1016 including a processor 1018, and a memory 1020. The processor 1018 can be implemented as a general purpose processor, an application specific integrated circuit (ASIC), one or more field programmable gate arrays (FPGAs), a group of processing components, or other suitable electronic processing components. The memory 1020 (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present application. The memory 1020 can be or include volatile memory or non-volatile memory. The memory 1020 can include object code components, script components, or any other type of information structure for supporting the various activities and information structures described in the present application. According to some embodiments, the memory 1020 is communicably connected to the processor 1018 via the processing circuit 1016 and can include computer code for executing (e.g., by the processing circuit 1016 and/or the processor 1018) one or more processes and/or functionalities described herein.

The memory 1020 is shown to include an event manager 1022, a notifications manager 1024, and an equipment controller 1026. The event manager 1022 is configured to determine an event based on data received from the monitoring device 1008. The event may be one of movement detected by a camera onboard the space controller 1000 (or located remotely from the space controller 1000 and communicably coupled to the space controller 1000). For example, the event may be a change in color (e.g., an amount of light, a wavelength of light, etc.) of an image taken by the camera over a period of time. In other embodiments, the event may be a face recognition in which an individual's face is presented in front of the camera and identifying information is determined based on the data received by the camera (e.g., in which the image captured by the camera is sufficiently similar to an image stored in memory 1020). In yet other embodiments, the event relates to a person's skin temperature (e.g., a surface temperature determined by an infrared camera or sensor that exceeds a predefined threshold, etc.). For example, the event manager may be configured to determine whether an occupant is cold or overheated based on surface temperature measurements of the occupant's skin taken by the infrared camera.

The notifications manager 1024 is configured to operate the user interface 1010 of the space controller 1000 based on information received from the event manager 1022. For example, the notifications manager 1024 may be configured to activate the touchscreen display in response to show video and/or sound from a space of the building in which movement is detected by the event manager 1022. In this way, the notifications manager 1024 operates similar to a nursery/baby monitor in which information is presented to a parent to notify them that their child has awakened or is moving in their bed. The type of notification generated by the notifications manager 1024 may vary based on the event (e.g., how much movement is detected, a noise level in comparison to a user-specified threshold value in memory 1020, etc.). In another embodiment, the notifications manager 1024 is configured to perform different routines based on programmable schedules that are saved into memory 1020. For example, the notifications manager 1024 may be configured as a sleep/wake training system for a child or an alarm clock. The notifications manager 1024 may be configured to activate different colored lights on the user interface 1010 depending on the time of day (e.g., a green light at 7:30 AM means it is ok to get out of bed in the morning, etc.) and to perform other controlled routines based on user defined schedules in memory 1020. These routines may be preprogrammed into the space controller 1000 or may be modified/updated by the user through the user interface 1010 (e.g., touchscreen) or remotely through an application on a mobile device.

The equipment controller 1026 is configured to control the operation of the controlled device 1014 based on one, or a combination of, sensor data, an event detected by the event manager 1022, and a notification from the notifications manager 1024. For example, the equipment controller 1026 may be configured to operate the controlled device 1014 based on a determination (e.g., by the event manager 1022) that a blanket has fallen off a child while they are asleep. The equipment controller 1026 may be configured to generate a control signal to activate and/or deactivate the controlled device 1014; for example, the equipment controller 1026 may be configured to activate a heater within the building to maintain the child at a comfortable temperature (e.g., to increase the temperature within the child's bedroom, etc.). In another embodiment, the equipment controller 1026 is configured to control HVAC equipment to adjust the environmental conditions based on preset values stored in memory 1020. For example, the equipment controller 1026 may be configured to adjust the temperature settings within a space based on presets assigned to different image identifiers. The identifiers may correspond with movement (e.g., hand gestures, etc.) or with different users/individuals (e.g., face recognition).

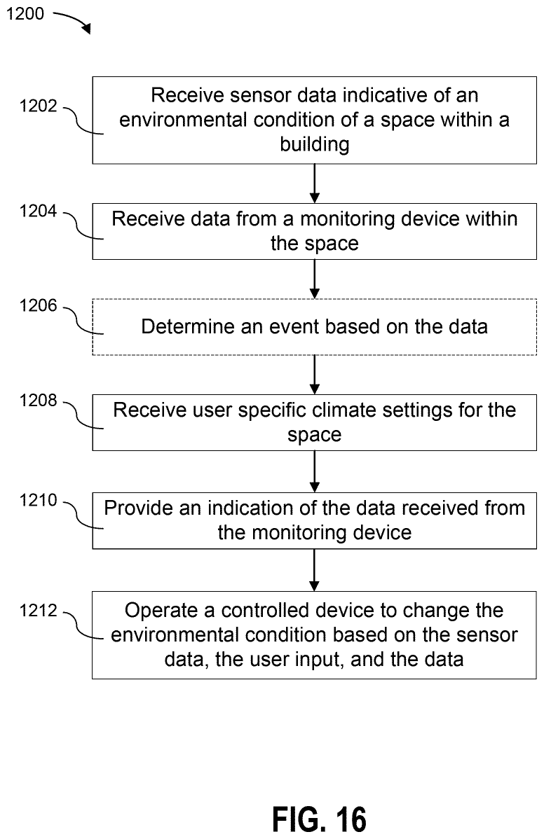

Referring to FIG. 16, a flow diagram of a method 1200 of operating a controlled device by a space controller to change an environmental condition is shown, according to an exemplary embodiment. The space controller and the controlled device may be the same or similar to the space controller 1000 and the controlled device 1014 described with reference to FIG. 15. At 1202, sensor data indicative of an environmental condition of a space within a building is received by the space controller (e.g., processing circuit 1016 from a sensor such as the temperature sensor 1002, the humidity sensor 1004, the air quality sensor 1006, etc.). The sensor may be positioned onboard the space controller or remotely from the space controller. Operation 1202 may include sampling sensor data from the sensor at a predefined rate (e.g., periodically, once every 5 seconds, etc.), averaging sensor data, and/or otherwise manipulating the sensor data to establish the environmental condition of the space.

At 1204, data from a monitored device within the space (e.g., the monitoring device 1008 and/or 1008′ of FIG. 15) is received by the processing circuit. Operation 1204 may include receiving at least one of sound or images from the monitoring device. For example, operation 1204 may include receiving livestream video from a camera in the space. At 1206, the processing circuit (e.g., the event manager 1022) determines an event based on the data. The event may be at least one of physical movement within the space, facial recognition, hand and/or body gestures, that a blanket has been removed from a person's body (e.g., temperature data indicating that a blanket has fallen off of a child while he/she is sleeping), or another image detectable occurrence (e.g., an activity that can be identified by analyzing at least one image from the camera). In a scenario in which the event is physical movement, operation 1206 may include collecting data from multiple images in memory (e.g., memory 1020) over a predefined time period (e.g., 1 s, 2 s, etc.) and comparing the images to identify any changes. For example, operation 1206 may include comparing changes in an amount of light within a region of the image and signaling that movement has occurred based on a size of the region in which the amount of light has changed (e.g., if a change in an amount of light in an area of the image greater than a predefined threshold within the predefined time period, etc.). In a scenario where the event is the removal of a blanket, operation 1206 may include determining an average temperature from the image data (e.g., from an image taken by an infrared camera) and signaling that the blanket has been removed if the average temperature is above a predefined threshold (e.g., if the temperature is within the range of a person's body temperature, etc.).

At 1208, user input including an environmental condition preference is received by the space controller. The environmental condition preference may include a climate setting for the space (e.g., a temperature, a humidity, an air quality, etc.). Operation 1208 may include receiving the environmental condition preference from a user interface (e.g., user interface 1010) of the space controller. At 1210, an indication of the data received from the monitoring device is provided by the space controller. In some embodiments, operation 1210 includes displaying the images from the camera on the display of the space controller. In other embodiments, operation 1210 includes generating an alert to notify an occupant of the space that an event has occurred.

At 1212, a controlled devices is operated to change the environmental condition of the space based on the sensor data, the user input, and the data from the monitoring device (e.g., the event). Operation 1212 may include controlling a heater to increase the temperature in the space based on a determination that a blanket has fallen off of a child while they are sleeping. In other embodiments, operation 1212 may include turning on a fan in the room if a predefined amount of movement is detected in the space (e.g., indicative of someone working out in the room or a person becoming overheated while they are asleep). In other embodiments, operation 1212 may include controlling an HVAC system to adjust the temperature of the room to a user's preference based on facial recognition using the monitoring device. In other embodiments, the method 1200 may include additional, fewer, and/or different operations.

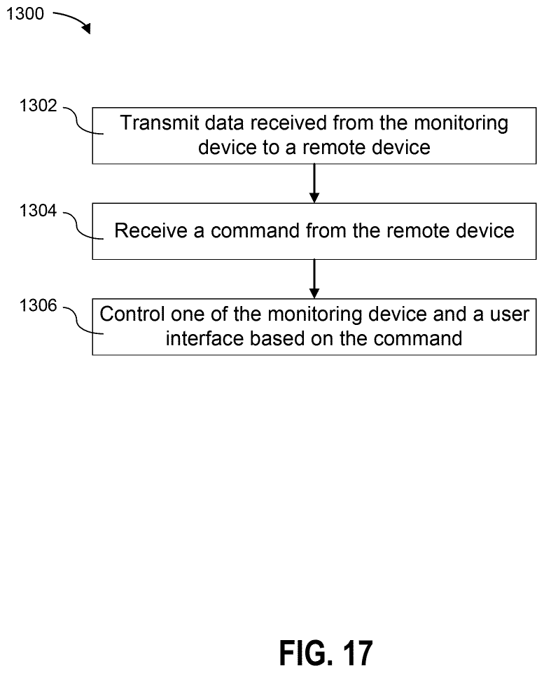

Referring now to FIG. 17, a flow diagram of a method 1300 of controlling a monitoring device by a space controller is shown, according to an illustrative embodiment. The space controller and the monitoring device may be the same or similar to the space controller 1000 and the monitoring device 1008 and 1008′ described with reference to FIG. 15. At 1302, data from the monitoring device is transmitted to a remote device. Operation 1302 may include receiving at least one of images or sound from the monitoring device by a processing circuit of the space controller, and transmitting the images and/or sound (e.g., via communications interface 1012) to a second space controller within the building. In other embodiments, operation 1302 may include transmitting the images and/or sound to a network (e.g., the cloud), a mobile phone, a tablet, a laptop computer, or another remote computing device.

At 1304, a command is received by the space controller from the remote device (in response to the transmitted data). The command may be a control signal that instructs the space controller how to operate the monitoring device and/or the user interface. At 1306, the space controller controls one of the monitoring device and the user interface based on the command. Operation 1306 may include adjusting an operating parameter of the monitoring device. For example, operation 1306 may include adjusting a position of the camera (e.g., tilting the camera), zooming, adjusting focus, or another control function. In other embodiments, operation 1306 includes controlling the user interface. For example, operation 1306 may include reproducing a sound signal and/or images that are received from the remote device when the space controller is functioning as an in-home telecom. In other embodiments, operation 1306 may include generating an alert to notify an occupant of the space that it is time to get out of bed. In other embodiments, the method 1300 may include additional, fewer, and/or different operations.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure. References herein to the positions of elements (e.g., “top,” “bottom,” “above,” “below,” “upward,” “downward,” etc.) are used to describe the orientation of various elements relative to one another with the user control device in its normal operating position as illustrated in the drawings.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

1. A space controller, comprising:
a housing;
a sensor coupled to the housing and configured to generate sensor data that is indicative of a condition of an environment;
a communications interface coupled to the housing and configured to communicate with a controlled device;
a camera;
a display configured to display images received from the camera and further configured to receive user input; and
a processing circuit positioned within the housing, the processing circuit configured to identify the condition based on the sensor data and operate the controlled device based on the condition and the user input.

2. The space controller of claim 1, wherein the display is a touch sensitive display, and wherein the display is configured to display the images from the camera in real-time, wherein the space controller is part of a building control system.

3. The space controller of claim 2, wherein the processing circuit is configured to determine an event based on the images received from the camera, and wherein the processing circuit is configured to operate the controlled device based on the event.

4. The space controller of claim 1, further comprising a microphone, wherein the processing circuit is configured to determine an event based on sound received from the microphone, and wherein the processing circuit is configured to operate the controlled device based on the event.

5. The space controller of claim 1, wherein the condition is one of a temperature of the environment surrounding the housing, a humidity of the environment surrounding the housing, an air quality of the environment surrounding the housing, or an amount of lighting in the environment surrounding the housing.

6. The space controller of claim 1, wherein the sensor comprises a temperature sensor configured to measure a temperature, wherein the user input comprises a temperature preference, and wherein the processing circuit is configured to operate the controlled device based on the temperature preference.

7. The space controller of claim 1, wherein the communications interface is configured to transmit the images received from the camera to a remote device and to receive commands from the remote device, and wherein the processing circuit is configured to control the camera based on the commands.

8. The space controller of claim 1, wherein the camera includes a CMOS sensor.

9. The space controller of claim 1, wherein the camera includes an infrared sensor.

10. A thermostat, comprising:
a space controller configured to operate a controlled device to affect an environmental condition of a space within a building, the space controller comprising a display configured to receive user input;
a sensor communicably coupled to the space controller and configured to generate sensor data that is indicative of the environmental condition of the space;
a camera communicably coupled to the space controller and configured to generate images, the display configured to display the images received from the camera; and
wherein the controlled device is communicably coupled to the space controller and operable to affect the environmental condition of the space based on the sensor data and the user input.

11. The thermostat of claim 10, wherein the display is a touch sensitive display, and wherein the display is configured to display the images from the camera in real-time.

12. thermostat of claim 11, wherein the space controller is configured to determine an event based on the images received from the camera, and wherein the space controller is configured to operate the controlled device based on the event.

13. The thermostat of claim 12, wherein the event is one of a movement, a face recognition, and a person's skin temperature.

14. The thermostat of claim 10, wherein the environmental condition is one of a temperature of the space, a humidity of the space, an air quality of the space, or an amount of lighting in the space.

15. The thermostat of claim 10, wherein the sensor comprises a temperature sensor configured to measure a temperature, wherein the user input comprises a temperature preference, and wherein the space controller is configured to operate the controlled device based on the temperature preference.

16. The thermostat of claim 10, wherein the camera includes a CMOS sensor.

17. The thermostat of claim 10, wherein the camera includes an infrared sensor.

18. A method, comprising:
receiving, by a processing circuit onboard a space controller, sensor data from a sensor, the sensor data indicative of an environmental condition of a space within a building;
receiving, by the processing circuit, images from a camera within the space;
receiving, by the processing circuit, user input comprising an environmental condition preference;
displaying, on a display of the space controller, the images from the camera; and
operating, by the processing circuit, a controlled device to change the environmental condition of the space based on the sensor data and the user input.

19. The method of claim 18, further comprising:
determining, by the processing circuit, an event based on the images from the camera; and
operating, by the processing circuit, the controlled device based on the event.

20. The method of claim 18, further comprising:
transmitting, by a communications interface onboard the space controller, images received from the camera to a remote device;
receiving, by the communications interface, a command from the remote device; and
controlling, by the processing circuit, one of the camera and a user interface of the space controller based on the command.
